(19) United States
(12) Patent Application Publication
(10) Pub. No.: US 2023/0028419 A1
(43) Pub. Date: Jan. 26, 2023

(54) A DISPENSER PUMP AND ELASTIC RESTORING MEANS FOR A DISPENSER PUMP

(71) Applicant: Asept International AB, Lund (SE)

(72) Inventor: Anders HILMERSSON, Lomma (SE)

(21) Appl. No.: 17/757,007

(22) PCT Filed: Dec. 8, 2020
(86) PCT No.: PCT/SE2020/051179

§ 371 Date: Jun. 7, 2022

(30) Foreign Application Priority Data
Dec. 9, 2019 (SE) 1951415-7

(51) Int. Cl. B05B 11/00

(52) U.S. Cl. CPC B05B 11/309; B05B 11/3074; B05B 11/3047; B05B 11/3077

(57) ABSTRACT

The disclosure relates to a dispenser pump (10) for manual dispensing of product (2) in fluid form out of a container (3) and for leakproof assembly to an opening (3A) of the container by means of a closure (4). The dispenser pump comprises a housing (20) adapted for being held fixed in relation to the container after assembly. The housing defining a pump chamber (21) with an inlet (22) configured for fluid communication with the inside of the container. The dispenser pump comprising at least one spring (30) and an actuator (40) configured for fluid communication with the inside of the pump chamber and a piston rod (42) fixedly connected to the actuator and arranged for reciprocating motion inside the pump chamber. The disclosure further relates to a spring (30) for a dispenser pump (10).

### TECHNICAL FIELD

The present disclosure relates to a press-type liquid pump, i.e. a dispenser pump for manual dispensing of product in fluid form out of a container and for leakproof assembly to an opening of the container by means of a closure and an elastic restoring means, such as a spring, for a dispenser pump. More specifically, the disclosure relates to a dispenser pump for manual dispensing of product in fluid form out of a container and for leakproof assembly to an opening of the container by means of a closure and a spring for a dispenser pump as defined in the introductory parts of independent claims.

### BACKGROUND ART

There are many different types of known press-type liquid pumps on the market for dispensing liquid products, i.e. liquid soaps or the like. Such press-type liquid pumps are commonly installed at an opening of a container for pumping and dispensing the liquid product in the container out of the container by means of pressing operation manually performed by a user, often done by pressing downwards on a pump pressing head or the like. Such liquid pumps generally have at least one elastic restoring function or device for restoring its pump pressing head to an original position after the user has removed the downward pressing force on the pressing head, and during the restoring of the pressing head, thereby sucking the liquid product within the container into a liquid reservoir of the liquid pump for pumping and dispensing by a next pressing, this first action is commonly known as “priming”.

In prior art press-type liquid pumps, the elastic restoring function/device is commonly arranged between a movable unit, e.g. including the pressing head and a piston rod, and a fixed unit, e.g. including a cylinder, in a pre-loaded manner, ensuring sufficient elastic force to enable the movable unit to be returned to its original position relative to the fixed unit after the user has removed the downward pressing force.

An example of a press-type liquid pump is found in U.S. Pat. No. 9,539,597 B2 disclosing restoring means in the form of a leaf/plate spring.

Many prior art press-type liquid pumps use a metal spring for the restoring function. Any metal spring for use in such liquid pumps rusts easily due to damp/moisture and/or contact with liquid if made of a metal prone for this, and a rusted spring affects the product quality, i.e. including the quality of the spring and the liquid product in the container). Furthermore, the cost of a metal spring is relatively high, in particular if made of metal less prone to rusting. Regarding recycling of the liquid pump, a metal spring must be separated from other plastic members of the liquid pump for separate recovery increasing recycling cost or in reality even risks making recycling impossible.

Some problems with prior art solutions are that keeping the elastic restoring means in a loaded state for a long time would result in creeping and fatigue failure of the elastic restoring means, ultimately resulting in an insufficient rebounding force to restore a movable unit into its start or original position affecting the amount of liquid being dispensed/outputted by the liquid pump, and/or that a leaf/plate spring achieved by axially loading a beam, e.g. as in U.S. Pat. No. 9,539,597 B2, must have a pre-determined initial shape/deflection for ensuring a defined and controlled movement/bending when loaded and that such a leaf/plate spring provides an uncontrolled deflection if the pressing force exceeds the critical force/load of the spring, hence, if that occurs, the strain/stress in the spring becomes so high that the spring breaks or is plastic/permanent deformed and stops working as a spring, this behaviour is also affected by variation in the spring material, aging and/or too high or low surrounding temperatures, meaning that such an axially loaded beam for a spring is not robust enough and/or that a leaf/plate spring achieved by axially loading a beam, e.g. as in U.S. Pat. No. 9,539,597 B2, require larger effort, i.e. about 80% of the maximal pressing force applied by a user for bending the spring must be reached/used before a sufficient movement of the pump is induced, whereafter reaching this force only a small increase of the pressing force is required to achieve a large movement/displacement/deplacement and thereby a large dispensed amount of product meaning that correct dosage is difficult to achieve/control and also that spill/spillage is much more imminent/likely to occur, wherefore this type of leaf/plate spring is difficult to use and increases risk of faulty dosage and spill of product and/or that a leaf/plate spring achieved by axially loading a beam, e.g. as in U.S. Pat. No. 9,539,597 B2, require a large volume and surrounding space when deflecting/bending during use so that its deflection is not hindered by any obstacle in its direction of deflecting in the radial direction.

There is thus a need for improvement of manual press-type liquid pumps comprising elastic restoring functionality via a spring for restoring their moving and pumping parts.

### SUMMARY

It is an object of the present disclosure to mitigate, alleviate or eliminate one or more of the above identified deficiencies and disadvantages in the prior art and solve at least the above mentioned problem/-s.

According to a first aspect there is provided a dispenser/dispenser pump for manual dispensing of product in fluid form out of a container and for leakproof assembly to an opening of the container by means of a closure, the dispenser pump defining a longitudinal axis and comprising a housing adapted for being held fixed and/or stationary and/or axially in relation to the container after assembly, the housing defining a pump chamber with an inlet configured for fluid communication with the inside of the container, the dispenser pump comprising at least one spring, an actuator, a spout being configured for fluid communication with the inside of the pump chamber and a piston rod fixedly connected to the actuator and arranged for reciprocating motion inside the pump chamber, wherein the actuator is configured for moving together with its piston rod reciprocally relative the housing between a first/start position and an end and/or intermediary and/or activated position to pump product out of the container via the spout by use of a pressing force applied by a user to the actuator to move the actuator from its first or start position towards the housing and closure into its end and/or intermediary and/or activated position with its piston rod moving inside the pump chamber along the longitudinal dispenser pump axis and an elastic force of the spring to return the actuator with piston rod from the end or intermediary/activated position to the first position after the pressing force is removed for sucking in product into the pump chamber, wherein all parts of the dispenser pump are manufactured by recyclable plastic material including the spring having a helical shape, that the spring comprises a wire and a first end and a second end, wherein the wire is provided with a free wire end at each of the first and second end of the spring. An advantage is that simpler and faster recycling of a dispenser pump is provided. This is especially true if all parts of the dispenser pump is manufactured by recyclable plastic material within the same family of plastic, e.g. polyolefin. The spring is an elastic restoring device/means for the dispenser pump. An advantage of having a recyclable plastic spring with free wire ends is that strain/stress in the wire at the free ends is reduced. An advantage is that the helically shaped spring made of recyclable plastics material requires a smaller cross-sectional area compared to prior art while still providing the same spring characteristics. An advantage is that the helically shaped spring of recyclable plastics material requires less plastic material compared to prior art while still providing the same spring characteristics.

According to some embodiments, the spring is configured for arrangement at least partly outside or fully/wholly outside the container and/or the pump housing and/or the pump chamber and/or the piston rod. An advantage is that at least a part of the spring is not soiled by any product providing improved and prolonged functionality as the risk of jamming due to no or at least less buildup of product in the spring is eliminated. An externally arranged spring does not have to be introducible through a container opening, wherefore the spring may be provided with a larger size/diameter enabling optimising the cross-section of the spring, i.e. its wire size/cross-section for least spring volume possible versus optimal spring length. Furthermore, the plastics material of the spring does not have to be approved for food application and do not have to stand the product (e.g. acid or the like) as it does not physically contact the food product.

According to some embodiments, the spring is configured for being arranged at least partly or fully/wholly inside the container and/or the pump housing and/or the pump chamber and/or the piston rod. Advantages are that the spring is at least partly shielded from or at least somewhat protected from direct sunlight and/or oxygen by the container and/or product increasing the durability and/or life span of the spring by eliminating or at least reducing the degradation/decomposition/embrittlement of the plastic spring material and/or that the user of the dispenser pump does not risk getting caught, nipped or pinched by the spring when using the dispenser pump. An inner spring enable providing a dispenser pump of lower height/building height for smaller pump and/or dispensing volumes and the same design/look as prior art dispenser pumps with metal springs.

In some embodiments, the spring is configured for being arranged inside the container and the pump housing and the pump chamber. An inner spring enable providing a dispenser pump of lower height/building height and the same design/look as prior art dispenser pumps with metal springs.

In some embodiments, the spring is configured for being arranged at least partly inside the container and the pump housing and the pump chamber and the piston rod. An inner spring enable providing a dispenser pump of lower height/building height and the same design/look as prior art dispenser pumps with metal springs.

In some embodiments, the spring is configured for being arranged at least partly inside the container and the pump housing and configured for being arranged at least partly outside the pump chamber and the piston rod.

According to some embodiments, the pump chamber is configured for being located at least partly below the closure. According to some embodiments, the pump chamber is configured for being located fully/wholly below the closure. Advantages are that the spring is at least partly shielded from or at least somewhat protected from direct sunlight and/or oxygen by the container and/or product increasing the durability and/or life span of the spring by eliminating or at least reducing the degradation/decomposition/embrittlement of the plastic spring material and/or enable providing a dispenser pump for smaller pump/dispensing volumes with lower height/building height and the same design/look as prior art dispensers with metal springs. According to some embodiments, the pump chamber and the area/surfaces which the product is in contact with during pumping and dispensing and after filling the pump chamber are configured for being located fully/wholly below the closure.

According to some embodiments, the spring is relaxed when the actuator is in its first/start position before its first use and/or stroke. An advantage is that creeping and fatigue failure of the plastic material of the spring is eliminated or at least reduced.

According to some embodiments, the spring is under compression when the actuator has returned to its start position after its first use and/or stroke from the start position to the end/activated position and back to the first/start position, this first stroke being a first priming stroke for enabling filling the pump chamber with product. One or more strokes may be required as priming strokes for filling the dispenser pump fully including its pump chamber and all other surfaces/parts/areas that are configured for being in contact with the product after the full priming is achieved, e.g. the spout. An advantage is that the time during which the plastic spring is pre-loaded is reduced as the spring is stored without being preloaded before use, whereby the risk of creeping and fatigue failure of the plastic material of the spring is eliminated or at least the adverse effect of this is reduced during its operation, i.e. during its functional life span.

According to some embodiments, the spring is under compression when the actuator is in its first/start position before its first use and/or stroke. An advantage is that any priming is possible to perform/achieve quicker than hitherto possible with prior art pumps as the product is sucked in during the return stroke.

According to some embodiments, the spring is configured for being arranged at least partly between the container/pump housing/chamber/closure and the spout. Hence, the outer size/diameter of the spring is not limited, at least not fully limited, by the size of the opening of the container, i.e. the spring can be assembled at the opening of any container with a suitably adapted closure.

According to some embodiments, the spring is configured for being arranged fully/wholly between the container/pump housing/chamber/closure and the spout. Hence, the outer size/diameter of the spring is not limited by the size of the container opening, i.e. the spring can be assembled at the opening of any container with a suitably adapted closure.

According to some embodiments, the spring is configured for being arranged fully/wholly below the closure and/or spout. This provides an advantage in decreasing the height of the dispenser pump, i.e. its part being arranged outside the container and also enable the same design/size/height as for prior art dispenser pump meaning easy replacement of prior art dispensers without requiring more space.

According to some embodiments, the spring is configured for being arranged at least partly at/adjacent/close to/above the spout. This enables decreasing the building height of the dispenser pump and/or increasing the length of the spring when used for dispenser pumps with fixed nozzles/spouts.

According to some embodiments, the spring is configured for being arranged inside the container and/or pump housing and/or pump chamber at a distance from the closure. This provides a possibility of optimizing and improving the guiding of the piston rod movement in the pump chamber. This is improved by adapting the height of the closure of the container such that an upper part of guiding and a lower part of guiding the piston rod are separatated at sufficient distance from each other for increased stability when the piston rod reciprocates.

According to some embodiments, the dispenser comprises one or check valve made of a recyclable plastics material and configured for being arranged at the pump chamber inlet and a discharge valve made of a recyclable plastics material and configured for being arranged at the spout, the check valve is configured for being closed, when the user presses down on the actuator and moves the piston rod towards the pump chamber inlet compressing the spring while forcing product out of the pump chamber upwards towards the spout opening the discharge valve for dispensing product, and for being opened when the user releases the actuator/removes the pressing force by means of the spring returning the piston rod and actuator back into the first/start position while drawing out product inside the container into the pump chamber to fill it, while closing the discharge valve(s) and sealing or closing the pump chamber to prevent product from flowing back into the container once the pump chamber is filled. Hence, this provides a sufficient suction pressure when the piston rod returns to suck in product in the pump chamber from the container without risking sucking in air into the pump chamber through the spout opening.

According to some embodiments, the dispenser comprises a dip tube made of a recyclable plastics material and configured to extend from the inlet of the pump chamber with an adaptable length into a predetermined depth of the container depending on the type/size/length/height of the container. An advantage is that the dispenser is adaptable to containers of different lengths/depths. Another advantage is that this enables the dip tube to be as simple designed as possible, e.g. having a smooth in- and outside and be easily manufactured as piece or yard goods, i.e. by the metre, e.g. the rolled up on reels or coils, and then easily cut into desired lengths when to be used.

According to some embodiments, the free end of the dip tube configured for receiving product is cut into a predetermined shape and/or angle and/or size and/or diameter. If a dip tube is manufactured in a continuous way by the metre, a preferred cut angle is e.g. between 10° to 30° at each of its ends, whereby waste/loss of material is eliminated. An advantage is that an angled end guarantees that even though this angled dip tube end contacts the bottom of the container, this end is not closed off and product can still enter it. One advantage is that the inlet area of this angle cut end is larger compared to a straight cut end meaning a lower drop of pressure is achieved at the end being beneficial for viscous products.

In some embodiments, the actuator and the spout are configured to be movable together as one unit. This enables using the spout as a handle for pumping.

In some embodiments, the actuator is configured to be movable and the spout is stationary/fixated. This enables prolonging the spring and aligning the pressing force with the centre axis of the spring for better stability when pumping.

According to some embodiments, the spring is a twin spring. This provides a spring with longer stroke length than hitherto possible with prior art springs and enables an optimization of the cross-sections of the springs giving a minimum total spring volume/spring material consumption/use in a given space. In particular if combined with polygonal cross-sections for the wires of each spring.

In some embodiments, the dispenser pump comprises at least two springs. This gives at least the same advantages as for the twin spring disclosed.

In some embodiments, one spring is configured for being arranged inside another spring. This gives at least the same advantages as for the springs disclosed and a better/more efficient use of available space for the springs.

In some embodiments, a first spring has a size and/or diameter being adapted for fitting/being received within a second spring. This gives at least the same advantages as for the springs disclosed and optimised and more compact design for the springs.

In some embodiments, a first spring has a size being adapted for fitting/being received within a second spring, the springs having essentially same or the same length. This gives at least the same advantages as for the springs disclosed and more compact design, in particular in regard of the building height for the springs.

In some embodiments, a first spring is adapted for fitting/being received within a second spring, the springs being concentrically arranged. This gives at least the same advantages as for the springs as disclosed and an optimization of the spring functionality as any pressing forced applied to them is better aligned giving an increased stability.

In some embodiments, the centre axis of the first spring is aligned with the centre axis of the second spring. This gives at least the same advantages as for other embodiments as disclosed and further improved control of spring functionality/stability when compressed and relaxed.

According to a second aspect, a spring for a dispenser pump according to any preceding aspect/embodiment is provided, wherein the spring has a helical shape and is made of a recyclable plastics material and is at least partly shaped as a cylindrical and/or non-cylindrical helical spring. An advantage is that simpler and faster recycling of a spring and/or dispenser pump comprising such a spring is provided. This is especially true if all parts of the dispenser pump are manufactured by recyclable plastic material within the same family of plastic, e.g. polyolefin.

According to some embodiments, the spring comprises and/or is configured with and/or is configured for manufacture into a non-cylindrical shape being substantially symmetrical or symmetrical around its centre axis. An advantage is that if a certain function and/or design of a spring demand another shape for the spring this manufacture enables adapting the spring accordingly.

According to some embodiments, the spring comprises and/or is configured with and/or is configured for manufacture into the shape of a helically winded wire with a polygonal cross-section. This achieves a stronger/more durable spring when available space for it is limited compared to traditional circular cross-sections.

According to some embodiments, the spring comprises and/or is configured with and/or is configured for manufacture into the shape of a helically winded wire with a square cross-section. This gives at least the same advantages as for the springs disclosed above and/or below and further that the use/consumption of plastic material for making a spring is optimised and reduced.

According to some embodiments, the spring comprises and/or is configured with and/or is configured for manufacture into the shape of a helically winded wire with a rectangular cross-section. This gives at least the same advantages as for the springs disclosed above and/or below and that use/consumption of plastic material for making a spring is optimised and reduced.

According to some embodiments, the spring comprises and/or is configured with and/or is configured for manufacture into the shape of a helically winded wire with a quadratic cross-section. This gives at least the same advantages as for the springs as disclosed above and/or below and that the use/consumption of plastic material for making the spring is minimized.

According to some embodiments, the spring comprises and/or is configured with and/or is configured for manufacture into the shape of a helically winded wire with a triangular cross-section. This enables adapting the strength/durability of the spring when available space for it is limited compared to traditional circular cross-sections.

According to some embodiments, the spring comprises and/or is configured with and/or is configured for manufacture into the shape of a helically winded wire with a conical cross-section. This enables adapting the strength/durability of the spring when available space is limited compared to traditional circular cross-sections by orienting and arranging/locating the conical shape in an optimised way, e.g. directing its apex optimally.

According to some embodiments, the spring comprises and/or is configured with and/or is configured for manufacture into the shape of a helically winded wire with a rounded cross-section, such as an oval and/or elliptical cross-section.

According to some embodiments, the spring(s) comprise(s) and/or is/are configured with and/or is/are configured for manufacture into the shape of one or more helically winded wires with a combination of rounded cross-section(s), such as oval and/or elliptical cross-section(s), and non-rounded cross-section(s), such as polygonal and/or square and/or rectangular and/or quadratic and/or triangular and/or conical cross-section. This enables adapting the strength/durability of the spring when available space for it is limited compared to traditional cross-sections, e.g. when available space is limited in either the vertical direction, i.e. along the length of the spring in a substantially parallel direction or in a parallel direction or the horizontal direction, i.e. in the radial direction in an inclined direction relative the longitudinal spring extension or in a substantially perpendicular or perpendicular direction relative the longitudinal direction of the spring or in more than one direction corresponding to these directions or any other direction.

According to some embodiments, the spring comprises a conical spring wire cross-section being arranged with its apex directed radially outwards from the spring centre and/or longitudinal axis.

According to some embodiments, the spring comprises a conical spring wire cross-section being arranged with its apex directed radially inwards towards the spring centre and/or longitudinal axis.

According to some embodiments, the spring is configured with and/or for manufacture into the shape of a helically winded wire with a polygonal cross-section having a/an width/extension in the radial direction of the spring being less, equal or larger than its height/thickness/extension in the axial/longitudinal direction of the spring.

According to some embodiments, the spring being/when at least partly shaped as a conical helical spring, its apex is configured for facing towards the container bottom.

According to some embodiments, the spring being/when at least partly shaped as a conical helical spring, its apex is configured for facing towards the container opening.

According to some embodiments, the spring, being/when at least partly shaped as a conical helical spring, its apex is configured for facing towards the spout.

In some embodiments, the spring comprises and/or is configured for manufacture into and/or is configured with the shape of a helically winded wire with an oval and/or elliptical cross-section.

According to some embodiments, the spring comprises a first end and a second end, wherein at least one end is flattened and/or face grinded. Advantages are that its assembly is simplified as the flattening works as an end guidance and its stability is improved during its compression and relaxation as the spring is more steadily supported at its end by a larger supporting area/surface. This reduces the load/stress or even eliminates excess stress/load in at least parts of the first and last winding of spring wire having a lower cross-sectional height, so that these end windings are not overloaded limiting maximum capacity of the spring.

According to some embodiments, both its first end and second end are flattened/face grinded. Advantages are that assembly is simplified as the flattening works as ends guidance and stability is improved during compression and relaxation as the spring is more steadily supported at each end by totally larger supporting area/surface. This reduces the load/stress or even eliminates excess stress/load in at least parts of the first and last winding of spring wire having a lower cross-sectional height, so that these end windings are not overloaded limiting maximum capacity of the spring.

According to some embodiments, the end is flattened and/or face grinded in a plane being perpendicular to the centre/longitudinal axis of the spring. Advantages are that assembly is simplified as this flattening works as an end guidance and the stability of the spring is improved during compression and relaxation as the spring is more steadily supported at its end by a larger and more distinctly made supporting area/surface. This reduces the load/stress or even eliminates excess stress/load in at least parts of the first and last winding of spring wire having a lower cross-sectional height, so that these end windings are not overloaded limiting maximum capacity of the spring.

According to some embodiments, the spring is configured for manufacture by injection moulding and/or machining. An advantage is that simpler, quicker and cheaper manufacture of a spring is provided. This in particular being the case when a spring of recyclable plastics comprising and/or being configured with and/or for manufacture into the shape of a helically winded wire with a polygonal cross-section having a small angle of relief, e.g. about 1°-2°, as this simplifies manufacture by enabling providing the mould with a smooth centre axle and two mould halves that are able to move perpendicular to the centre axle of the mould and when the mould halves are opened the spring is easily removed from the mould. Such a polygonal shape of a spring wire cross-section is also of advantage when manufacturing such a spring of recyclable plastics by means of turning in a lathe or the like device.

In some embodiments, the spring is configured with a helical envelope surface formed by the outer surface of the helically winded wire, which windings form an at least partly open structure when the spring is relaxed.

In some embodiments, the spring comprises one or more open ends. In some embodiments, the spring comprises one or more open ends with one or more free spring wire ends.

In some embodiments, the spring comprises one or more closed ends. In some embodiments, the spring comprises one or more closed ends with one or more free spring wire ends.

In some embodiments, the spring comprises one or more closed and grounded ends. In some embodiments, the spring comprises one or more closed and grounded ends with one or more free spring wire ends.

In some embodiments, the spring comprises one or more double closed and grounded ends. In some embodiments, the spring comprises one or more double closed and grounded ends with one or more free spring wire ends.

In some embodiments, the housing of the dispenser pump is made of a recyclable plastics material. In some embodiments, the housing including the pump chamber with an inlet are made of a recyclable plastics material. In some embodiments, the actuator of the dispenser pump is made of a recyclable plastics material. In some embodiments, the housing and its pump chamber with inlet and the actuator of the dispenser pump are made of a recyclable plastics material. In some embodiments, the spout of the dispenser pump is made of a recyclable plastics material. In some embodiments, the housing and its pump chamber with inlet and the actuator and the spout of the dispenser pump are made of a recyclable plastics material. In an embodiment, the piston rod of the dispenser pump is made of a recyclable plastics material. In some embodiments, the closure of the dispenser pump for leakproof assembly to an opening of the container is made of a recyclable plastics material. In some embodiments, the closure of the dispenser pump for leakproof assembly to an opening of the container comprises one or more gaskets being made of a recyclable plastics material. In some embodiments, the closure of the dispenser pump for leakproof assembly to an opening of the container and its one or more gaskets are made of a recyclable plastics material. In some embodiments, the housing and its pump chamber with inlet and the actuator and the spout and the piston rod of the dispenser pump are made of a recyclable plastics material. In some embodiments, the housing and its pump chamber with inlet and the actuator and the spout and the piston rod and the spring of the dispenser pump are made of a recyclable plastics material. In some embodiments, the housing and its pump chamber with inlet and the actuator and the spout and the piston rod and the spring and the closure of the dispenser pump are made of a recyclable plastics material. In some embodiments, the housing and its pump chamber with inlet and the actuator and the spout and the piston rod and the spring and the closure and its gasket(s) of the dispenser pump are made of a recyclable plastics material. In some embodiments, the housing and its pump chamber with inlet and the actuator and the spout and the piston rod and the spring and the closure and the dip tube of the dispenser pump are made of a recyclable plastics material. In some embodiments, the housing and its pump chamber with inlet and the actuator and the spout and the piston rod and the spring and the check valve(s) of the dispenser pump are made of a recyclable plastics material. In some embodiments, the housing and its pump chamber with inlet and the actuator and the spout and the piston rod and the spring and the closure and its gasket(s) and the check valve(s) and the dip tube(s) of the dispenser pump are made of a recyclable plastics material. In some embodiments, the housing and its pump chamber with inlet and the actuator and the spout and the piston rod and the spring and the closure and its gasket(s) and the check valve(s) and the dip tube(s) and the discharge valve(s) of the dispenser pump are made of a recyclable plastics material. In some embodiments, the housing and its pump chamber with inlet and the actuator and the spout and the piston rod and the spring and the closure and its gasket(s) and the check valve(s) and the dip tube(s) of the dispenser pump are made of a recyclable plastics material, which dispenser pump is configured to be recycled with the container made of recyclable plastics material when assembled thereto or to be recycled separately when not assembled to the container. Effects and features of the second aspect are to large extent analogous to those described above in connection with the first aspect. Embodiments mentioned in relation to the first aspect are largely compatible with the second aspect.

The present disclosure will become apparent from the detailed description below. The detailed description and specific examples disclose preferred embodiments of the disclosure by way of illustration only. Those skilled in the art understand from guidance in the detailed description that changes and modifications may be made within the scope of the disclosure.

It is to be understood that the herein disclosed disclosure is not limited to the particular component parts of dispenser/spring/-s/described or steps of a method/-s described since such dispenser/spring/-s and method/-s may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, e.g., reference to “a unit” or “the unit” may include several devices, and the like. Further, the words “comprising”, “including”, “containing” and similar wordings does not exclude other elements or steps.

### BRIEF DESCRIPTIONS OF THE DRAWINGS

The above objects, as well as additional objects, features and advantages of the present disclosure will be more fully appreciated by reference to the following illustrative and non-limiting detailed description of example embodiments of the present disclosure, when taken in conjunction with the accompanying drawings.

FIG. 1A shows a perspective view of a dispenser or dispenser pump—at an angle from above before assembly to a container or after being disassembled from a container—according to an embodiment of the present disclosure.

FIG. 1B shows a perspective view of the dispenser pump of FIG. 1A at an angle from below before being assembled to a container or after being disassembled from a container visualized with a bidirectional arrow.

FIG. 1C shows a cross-sectional view of the dispenser pump along line A-A in FIG. 1A.

FIG. 2A shows a perspective view of a dispenser or dispenser pump—at an angle from above before being assembled to a container or after being disassembled from a container—according to another embodiment of the present disclosure.

FIG. 2B shows a perspective view of the dispenser pump of FIG. 2A at an angle from below before assembly to a container or after disassembly from a container visualized with a bidirectional arrow.

FIG. 2C shows a cross-sectional view of the dispenser pump along line B-B in FIG. 2A.

FIG. 3A shows a perspective view of a dispenser or dispenser pump—at an angle from above before assembly to a container or after disassembly from a container—according to yet another embodiment of the present disclosure.

FIG. 3B shows a perspective view of the dispenser pump of FIG. 3A (at an angle from below before assembly to a container or after disassembly from a container visualized with a bidirectional arrow).

FIG. 3C shows a cross-sectional view of the dispenser pump along line C-C in FIG. 3A.

FIG. 4A shows a perspective view of a dispenser or dispenser pump—at an angle from above before assembly to a container or after disassembly from a container—according to still another embodiment of the present disclosure.

FIG. 4B shows a perspective view of the dispenser pump of FIG. 4A (at an angle from below before assembly to a container or after disassembly from a container visualized with a bidirectional arrow).

FIG. 4C shows a cross-sectional view of the dispenser pump along line D-D in FIG. 4A according to an embodiment of the present disclosure.

FIG. 5A shows a perspective view of a dispenser or dispenser pump—at an angle from above before assembly to a container or after disassembly from a container—according to another embodiment of the present disclosure.

FIG. 5B shows a perspective view of the dispenser pump of FIG. 5A (at an angle from below before assembly to a container or after disassembly from a container visualized with a bidirectional arrow).

FIG. 5C shows a cross-sectional view of the dispenser pump along line E-E in FIG. 5A according to an embodiment of the present disclosure.

FIG. 6 shows a perspective view of a dispenser or dispenser pump—at an angle from above before assembly to a container or after disassembly from a container—according to still another embodiment of the present disclosure.

FIG. 7A shows a perspective view of a dispenser or dispenser pump—at an angle from above before assembly to a container or after disassembly from a container—according to an embodiment of the present disclosure.

FIG. 7C shows a cross-sectional view of the dispenser pump along line F-F in FIG. 7A according to an embodiment of the present disclosure.

FIGS. 8A and 8B show some different possible and suitable cross-sections of a part of the dispenser pump according to embodiments of the present disclosure, FIG. 8A showing in particular six different views I-VIII of a part of the dispenser pump according to embodiments of the present disclosure.

FIG. 9A shows a possible and suitable spring in cross-section in the upper view along line G-G of the lower perspective view to use in the dispenser pump according to embodiments of the present disclosure.

FIG. 9B shows a possible and suitable spring in cross-section in the upper view along line H-H of the lower perspective view to use in the dispenser pump according to embodiments of the present disclosure.

FIG. 9C shows a possible and suitable spring in cross-section in the upper view along line I-I of the lower perspective view to use in the dispenser pump according to embodiments of the present disclosure.

FIG. 9D shows a possible and suitable spring in cross-section in the upper view along lineJ-J of the lower perspective view to use in the dispenser pump according to embodiments of the present disclosure.

FIG. 10A shows a possible and suitable spring in cross-section in the upper view along line K-K of the lower perspective view to use in the dispenser pump according to embodiments of the present disclosure.

FIG. 10B shows a possible and suitable spring in cross-section in the upper view along line L-L of the lower perspective view to use in the dispenser pump according to embodiments of the present disclosure.

FIG. 10C shows a possible and suitable spring in cross-section in the upper view along line M-M of the lower perspective view to use in the dispenser pump according to embodiments of the present disclosure.

FIG. 10D shows a possible and suitable spring in cross-section in the upper view along line N-N of the lower perspective view to use in the dispenser pump according to embodiments of the present disclosure.

### DETAILED DESCRIPTION

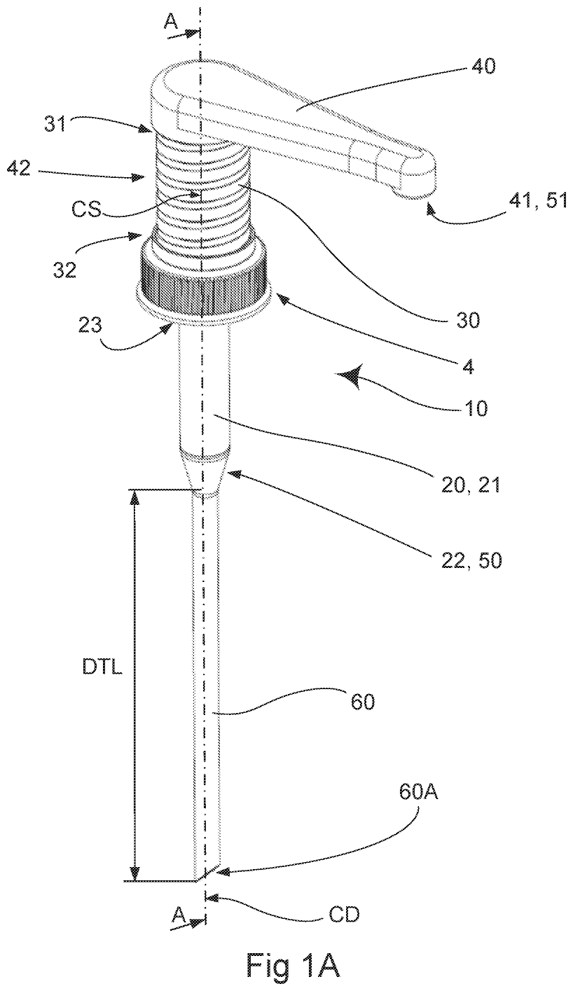

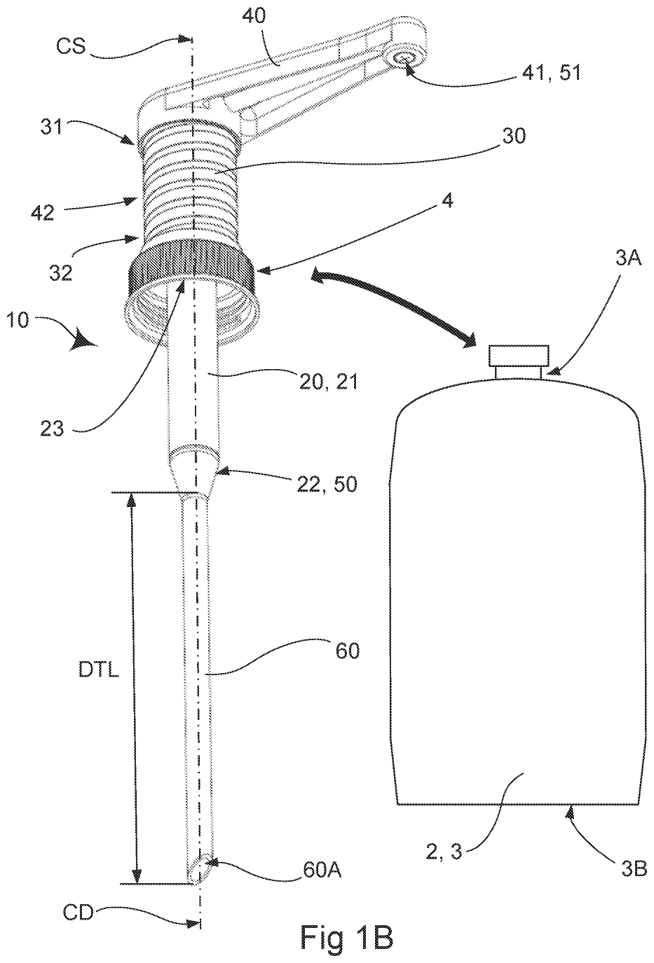

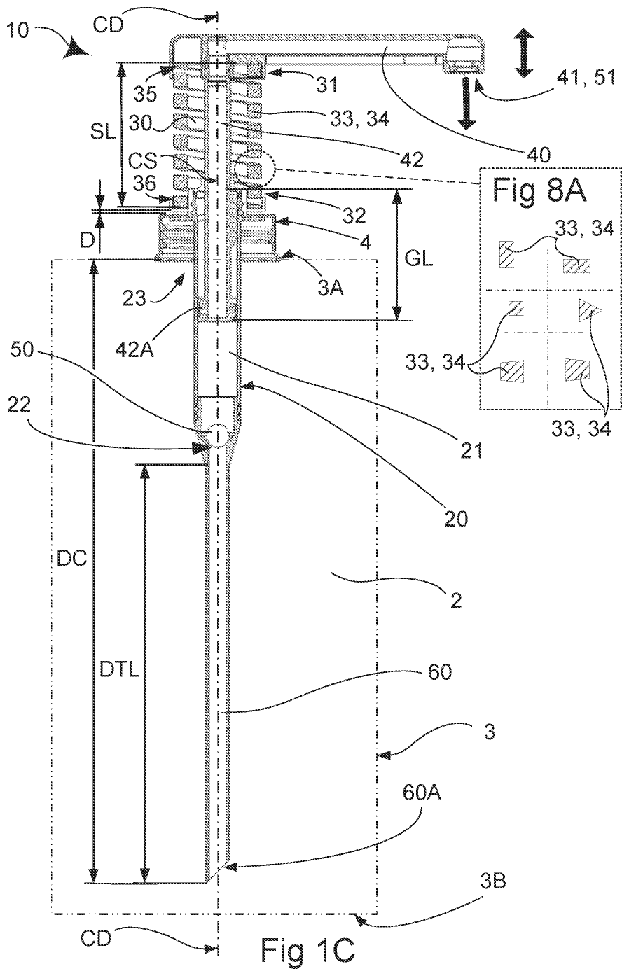

The present disclosure will now be described with reference to the accompanying drawings/FIGS. 1A to 10D, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

FIGS. 1A to 7C show a dispenser or dispenser pump 10 for manual dispensing of product 2 in fluid form out of a container 3. This dispenser pump 10 is configured for leakproof assembly to an opening 3A of the container by means of a closure 4. This leakproof assembly by the closure 4 is in one embodiment detachable but in other embodiments not detachable without breaking or destroying the closure 4 and/or dispenser pump 10 and/or container 3 and/or its opening 3A, e.g. due to using welding or gluing or clamping as ways of assembly.

In the cross-sectional views of FIGS. 1C, 2C, 3C, 4C, 5C and 7C, a centre or longitudinal axis CD of the dispenser pump 10 extends in the vertical direction in the plane of the associated figure and in parallel with the longitudinal direction of the dispenser pump 10 while in the perspective views of FIGS. 1A, 1B, 2A, 2B, 3A, 3B, 4A, 4B, 5A, 5B and 7A this centre axis CD extends in parallel with the longitudinal direction of the physical dispenser pump.

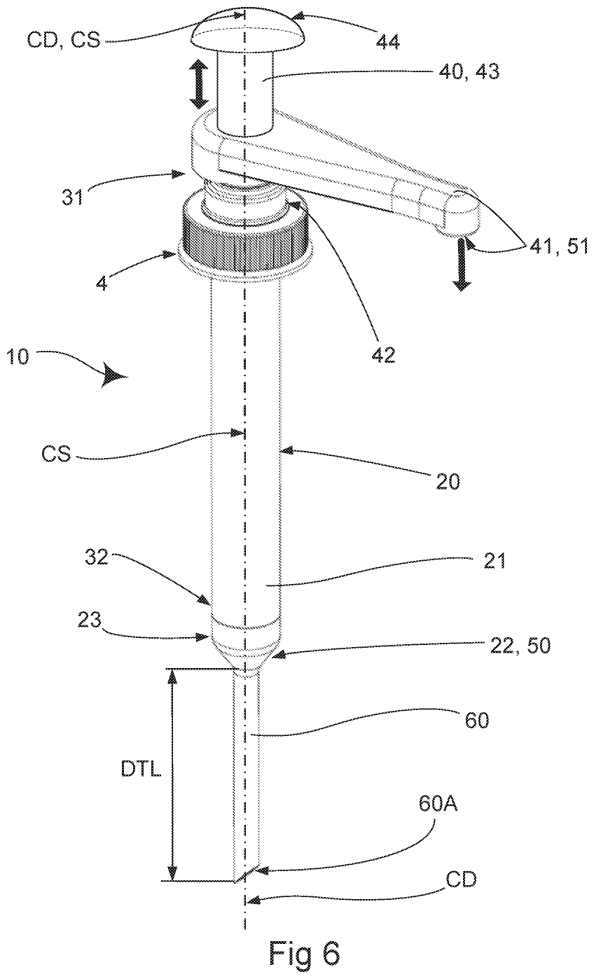

The first aspect of this disclosure shows the dispenser pump 10 that defines the longitudinal or centre axis CD. The dispenser pump 10 comprises a housing 20 adapted for being held fixed/stationary/axially in relation to the container 3 after assembly to the container by means of the closure 4. The housing defines an inner pump chamber 21 with an inlet 22 configured for fluid communication with the inside of the container and an outlet 23 configured for fluid communication with the outside of the container 3. The dispenser pump 10 comprises at least one spring 30 and a movable actuator 40. The dispenser pump 10 comprises a spout 41 configured for fluid communication with the inside of the pump chamber 21 via its outlet 23. In some embodiments, the spout 41 is preceded by one or more check valves 50 to facilitate the functionality of the spout when subjected to negative or suction pressure when product 2 is sucked in. The actuator 40 and the spout 41 is in one embodiment as shown on FIGS. 1A to 5C and 7A to 7C together with a button arrangement 43 one common movable unit or module, i.e. spout 41 moves together with the actuator 40 when the actuator is moved or pressed. The actuator 40 and the spout 41 are in another embodiment as shown on FIG. 6 separate entities, i.e. only the actuator 40 is movable together with the button arrangement 43 as one common movable unit/module, i.e. the spout 41 does not move together with the actuator 40 and/or its button arrangement 43 when the actuator is moved/pressed, instead the spout is fixated/stationary. In FIG. 6, the actuator 40 is provided with a rounded end 44, similar to a button to be pushed or pressed when the dispenser pump 10 is operated. The spout 41 comprises the final/last outlet for dispensing product 2 out of the container 3 into the surrounding; this dispensing of product is visualized by an arrow in FIGS. 1C, 2C, 3C, 4C, 5C and 7C. The movable actuator 40 comprises a piston rod 42 fixedly connected to the actuator and arranged for reciprocating motion inside the inner pump chamber 21 when the actuator moves up and down, visualized with a bidirectional straight arrow in FIGS. 1C, 2C, 3C, 4C, 5C and 7C. The actuator 40 is configured for moving together with its piston rod 42 reciprocally relative the housing 20 between a first or start position as shown in FIGS. 1A to 4C and an end or intermediary or activated position (not shown) to pump product 2 out of the container 3 via its opening 3A. This is done by firstly using a pressing force applied by a user to the actuator 40 moving the actuator from its first/start position towards the housing 20 and closure 4 into its end and/or intermediary and/or activated position with its piston rod 42 moving inside the inner pump chamber 21 along the longitudinal dispenser pump axis CD as a first stroke for priming. Then, subsequently an elastic force of the spring 30 being compressed by this first stroke returns the actuator 40 with its piston rod 42 from the end and/or intermediary and/or activated position back to the first position after the pressing force is removed while/as the spring is relaxing. Actuator 40 is configured for moving together with its piston rod 42 reciprocally relative the housing 20 between a first or start position as shown in FIGS. 1A to 7C and an end or intermediary or activated position (not shown) to pump product 2 out of the container 3 via its opening 3A. The spout 41 does not move together with actuator 40 and/or its piston rod 42/button arrangement 43, 44 in the embodiment shown in FIG. 6 when the actuator is moved/pressed, instead the spout stands still in the vertical direction, i.e. spout is vertically fixated/stationary.

After this first stroke performed by the user of the dispenser pump 10 and its actuator 40 as explained above down in the downwards direction visualized by the downward pointing arrow of the bidirectional arrow of FIGS. 1C, 2C, 3C, 4C, 5C and 7C and the return of the actuator 40 back up in the upwards direction visualized by the upwards pointing arrow of the bidirectional arrow of FIGS. 1C, 2C, 3C, 4C, 5C and 7C, the inner pump chamber 21 has been filled via its inlet 22 by product 2 from the container 3 via its opening 3A. In some applications, more than one stroke is required to fill the inner pump chamber 21 for priming.

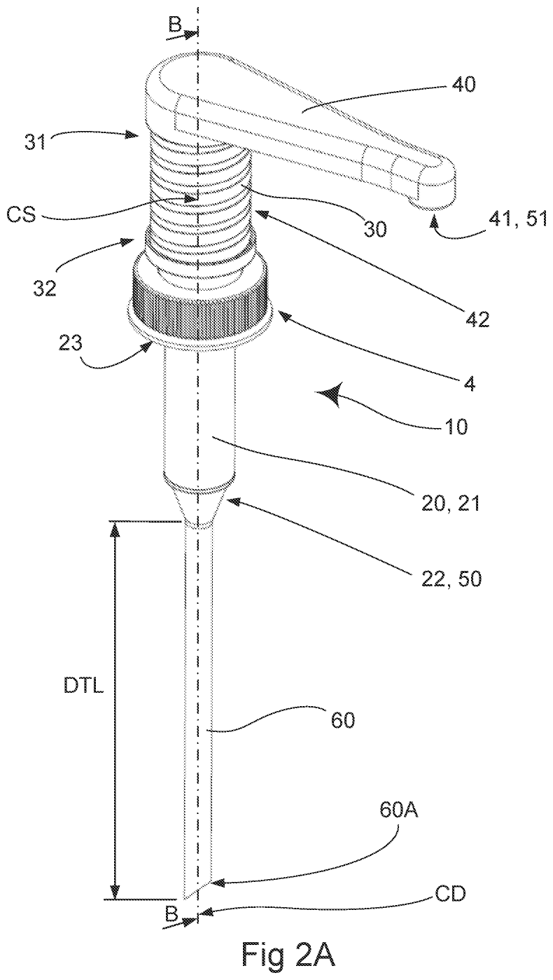

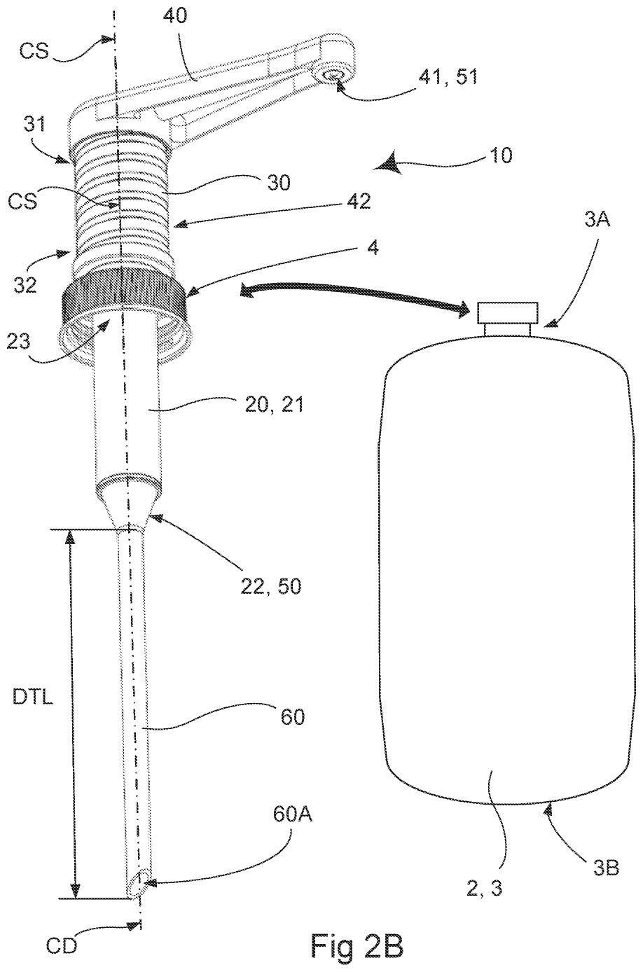

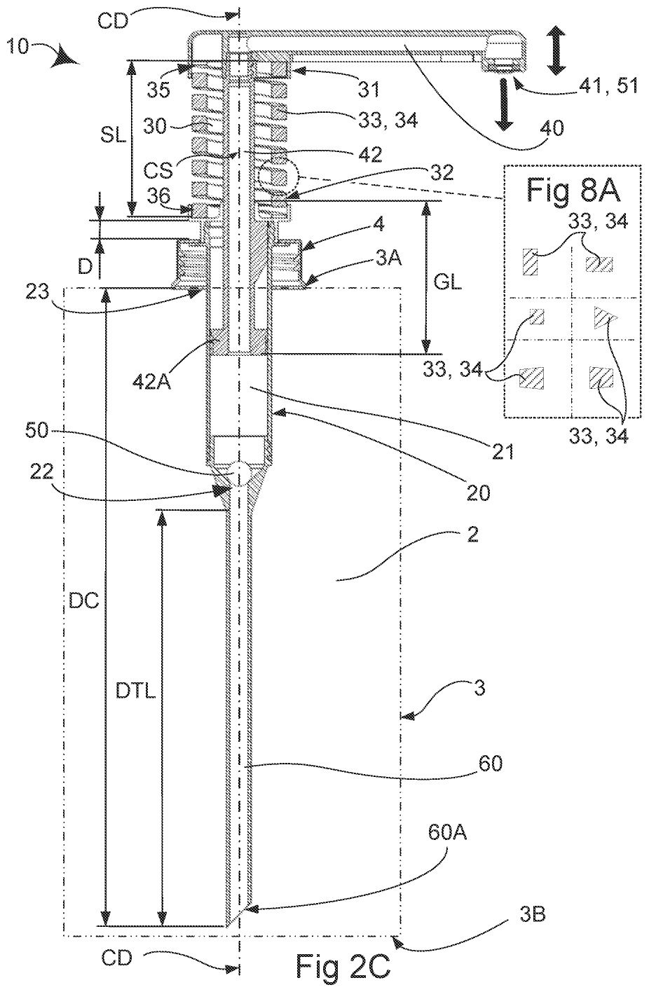

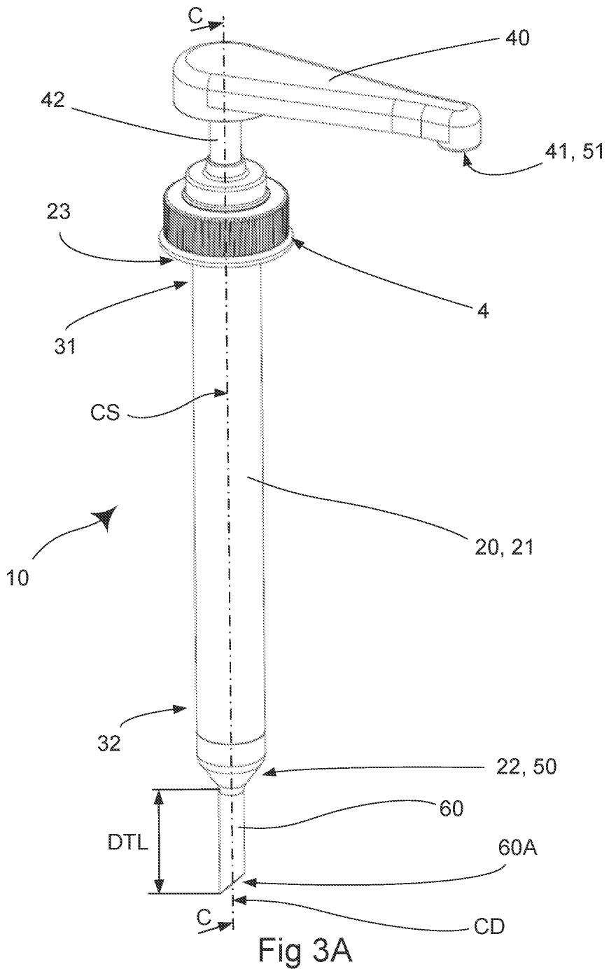

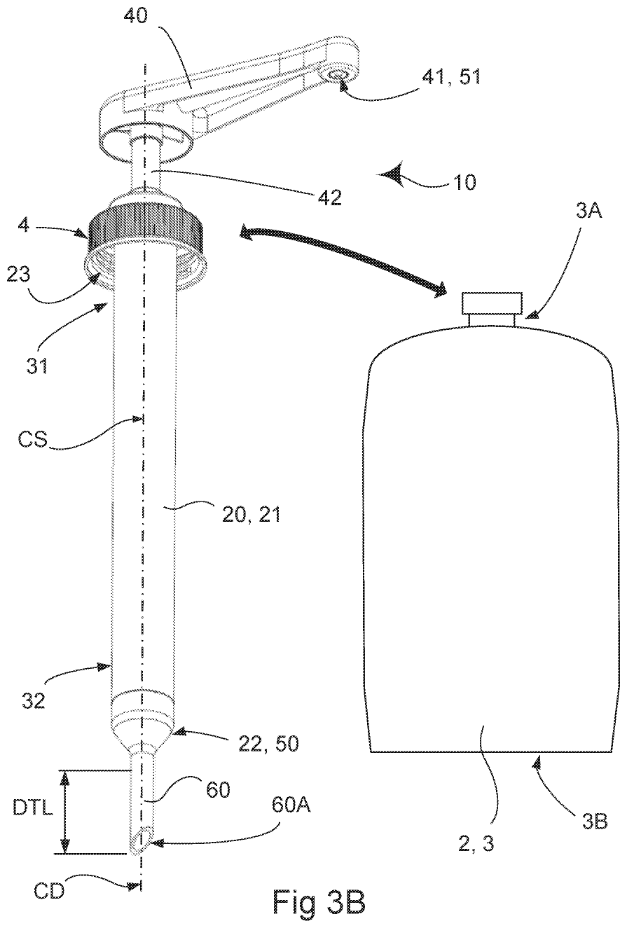

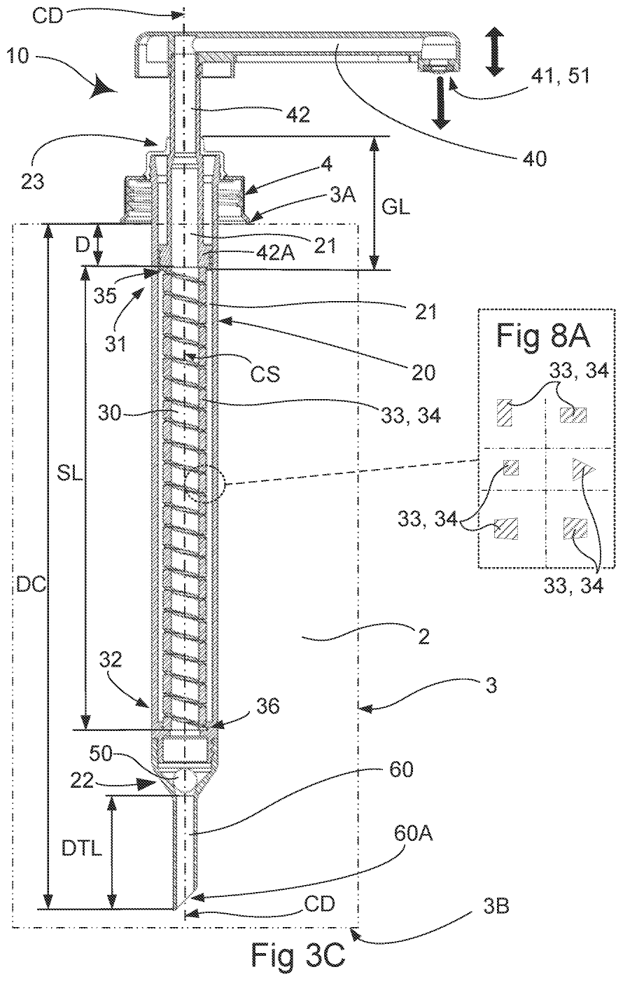

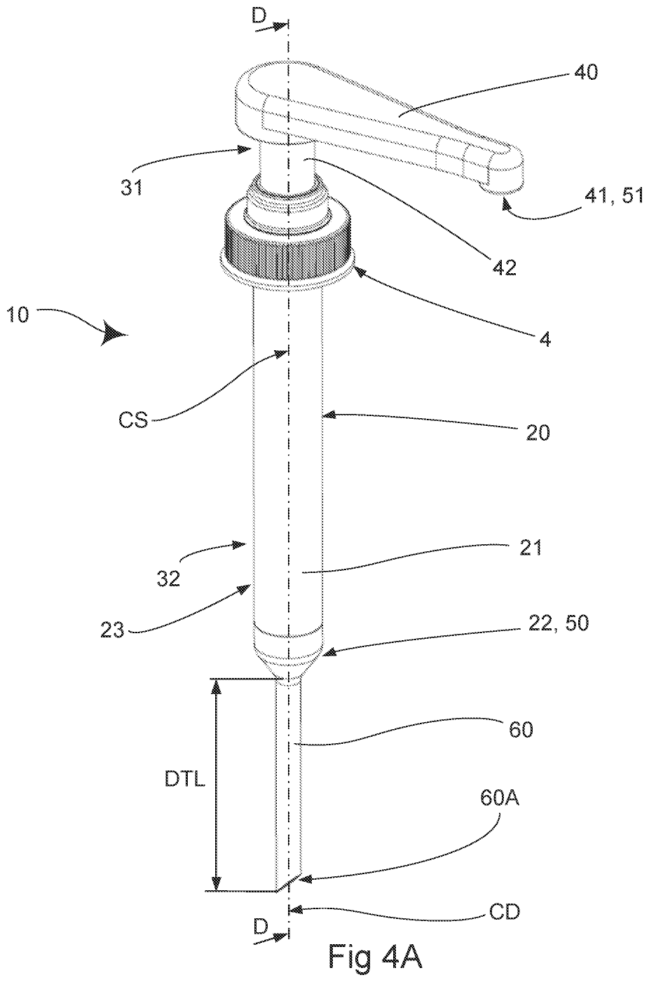

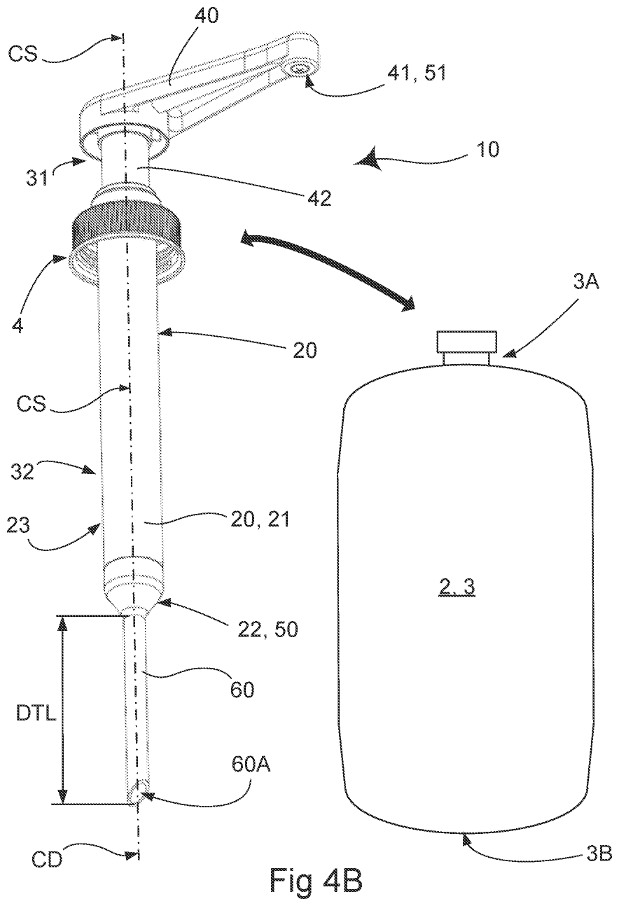

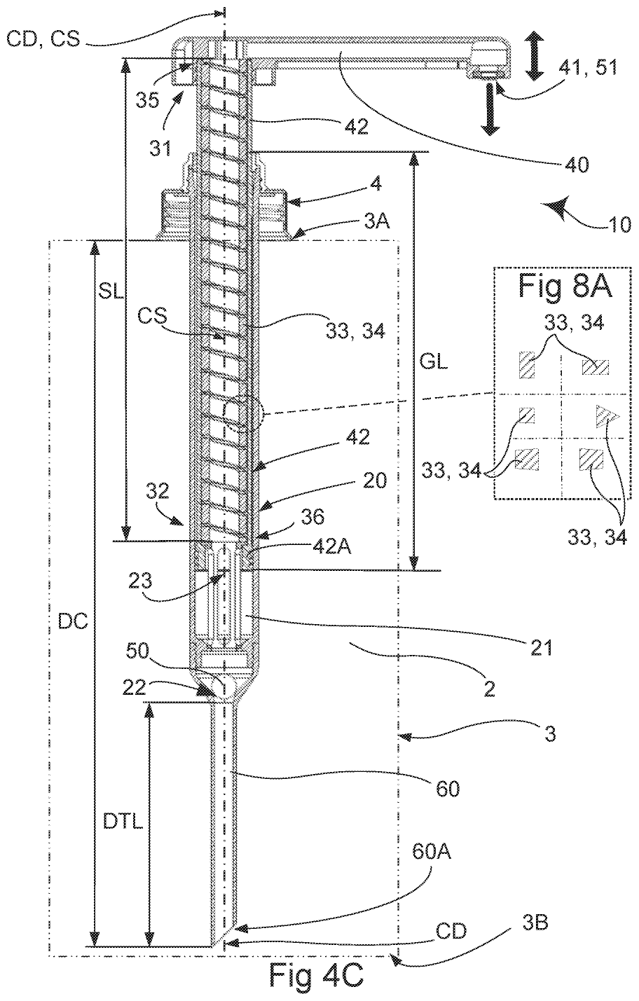

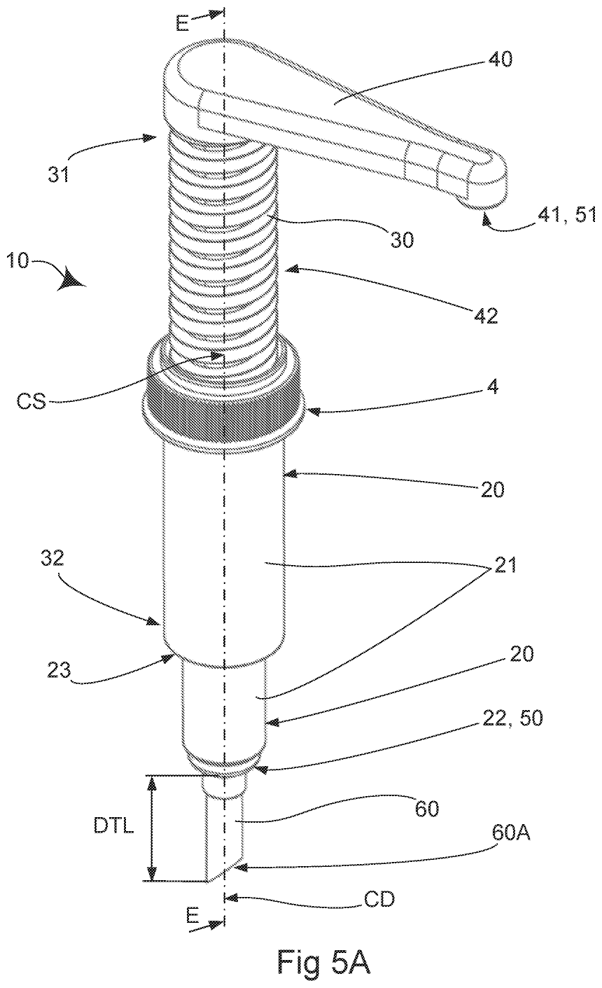

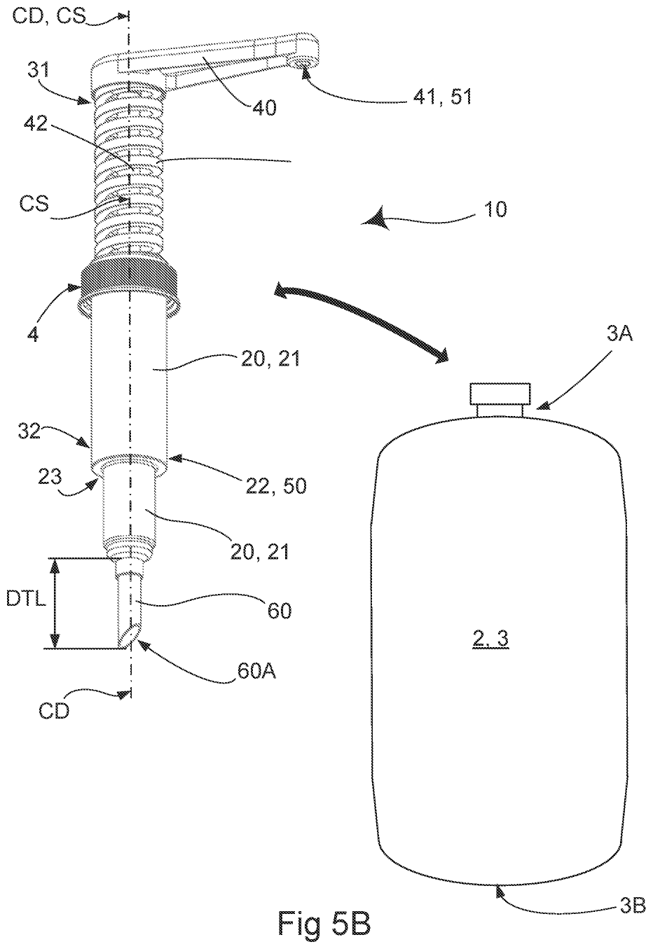

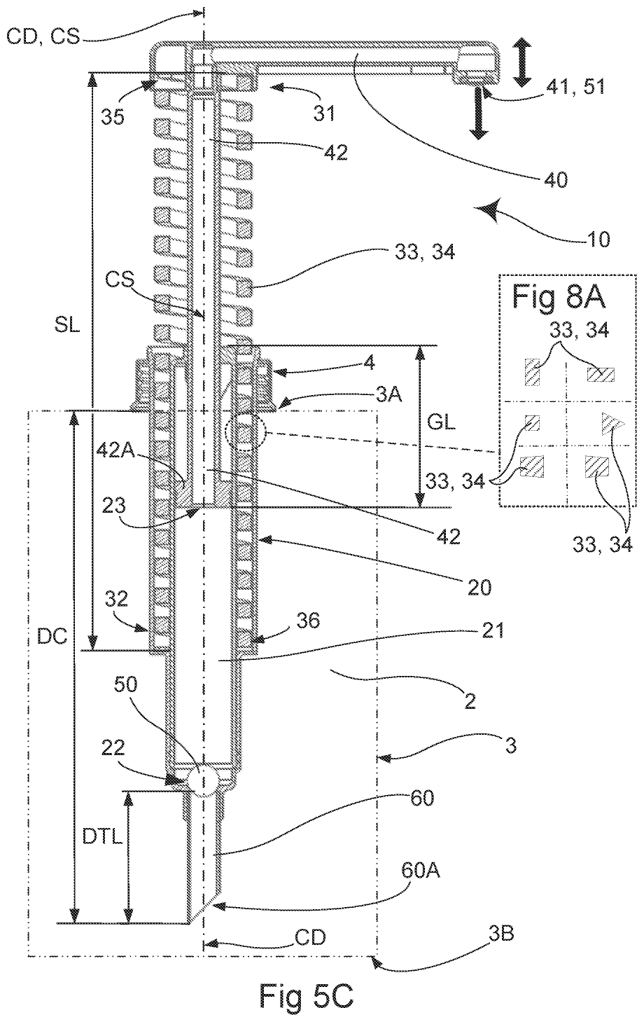

The spring 30 has in some or all embodiments a helical shape as shown in FIGS. 1C, 2C, 3C, 4C, 5C, 7C and 9A to 10D. The spring 30 is made of recyclable plastics material in some or all embodiments. The spring 30 is configured for arrangement outside the container 3 and/or the pump housing 20 and/or the inner pump chamber 21 and/or the piston rod 42, e.g. shown in embodiments of FIGS. 1A to 2C. The spring 30 is configured for being arranged at least partly or fully/wholly inside container 3 and/or the pump housing 20 and/or the inner pump chamber 21 and/or the piston rod 42, e.g. see embodiments of FIGS. 3A to 5C. In some embodiments, e.g. in FIGS. 1A to 1C, 2A to 2C, 3A to 3C, 4A to 4C, 5A to 5C, and 7A to 7C, the pump chamber 21 is configured for being located below the closure 4. In some embodiments, e.g. in FIGS. 3A and 3B and as shown in FIGS. 3C, the spring 30 is placed fully/wholly inside the inner pump chamber 21. In some embodiments, e.g. in FIGS. 3A and 3B and as shown in FIGS. 3C, the spring 30 is placed fully/wholly inside the housing 20. In some embodiments, e.g. in FIGS. 4A, 4B, 5A, 5B and as shown in FIGS. 4C and 5C, the spring 30 is placed at least partly inside the housing 20. In some embodiments, e.g. as in FIGS. 4A, 4B, 5A, 5B and as shown in FIGS. 4C and 5C, the spring 30 is placed at least partly inside the housing 20 and at least partly outside the housing 20. In some embodiments, e.g. as in FIGS. 4A and 4B and as shown in FIGS. 4C, the spring 30 is placed inside the piston rod 42. In some embodiments, e.g. in FIGS. 4A and 4B and as shown in FIGS. 4C, the spring 30 is placed inside both the housing 20 and the piston rod 42 as the piston rod is configured to move inside the housing. Here, the piston rod 42 is hollow and somewhat wider than in the other shown embodiments. In embodiments of FIGS. 1A to 4C, the piston rod 42 is tubular and forms part of a fluid channel for outflow of product 2, and is, in other embodiments, solid. In some embodiments (not shown), the fluid channel could be arranged outside the piston rod to enable flow of product 2 out of the dispenser pump 10.

As shown in the embodiments of FIGS. 1A to 4C, the spring 30 is relaxed when the actuator 40 is in its first/start position before its first use/stroke. In other embodiments, the spring 30 is under compression when the actuator 40 has returned to its start position after its first use/stroke from the start position to the end/activated position and back to the first/start position. In some embodiments, this first stroke is a priming stroke and/or a first priming stroke if more than one stroke is required for enabling filling the inner pump chamber 21 with product 2 until the last priming stroke filling up the dispenser pump 10 fully. In some embodiments, the spring 30 is under compression when the actuator 40 is in its first/start position before its first use/stroke, i.e. the spring is pre-compressed or pre-loaded, e.g. at/during/by assembly into the dispenser pump 10 or before assembly therein or after a stroke being a first stroke and/or a first or second or third or fourth or one of more priming strokes and/or a full-pump/-ing stroke after the priming is finalized by filling up the pump chamber 21 and the remaining parts of the dispenser pump 10 required for continuous and “full”/normal dispensing of product 2.

In some embodiments, such as in FIGS. 1A, 1B, 2A, 2B and shown in FIGS. 1C and 2C, the spring 30 is configured for being arranged between the container 3, the pump housing 20, the chamber 21, the closure 4 and the spout 42 as seen in the axial or longitudinal direction CD of the dispenser pump 10. In some embodiments, such as in FIGS. 3A, 3B and shown in FIG. 3C, the spring 30 is configured for being arranged below the closure 4 as seen in the axial or longitudinal direction CD of the dispenser pump 10. In some embodiments, such as in FIGS. 2A, 2B, 3A, 3B and shown in FIGS. 2C and 3C, the spring 30 is configured for being arranged inside the container 3 and/or pump housing 20 and/or pump chamber 21 at a distance D from the closure 4 as seen/measured in the axial or longitudinal direction CD of the dispenser pump 10.

The dispenser pump 10 comprises one or more check valves 50 made of a recyclable plastics material. The check valve 50 is shown in the shape of a rounded element, such as a sphere or ball in the embodiments of FIGS. 1C, 2C, 3C and 4C, but could in other embodiments be differently shaped. The check valve 50 is configured for being arranged at/adjacent the pump chamber inlet 22. The dispenser pump 10 comprises one or more discharge valves 51 made of a recyclable plastics material and configured for being arranged at the spout 41. The discharge valve 51 could in other embodiments be differently shaped to fit materials and needs. The check valve 50 is configured for being closed, when the user presses down on the actuator 40 after the first priming stroke(s) as explained above is/are performed, thereby moving the piston rod 42 towards the pump chamber inlet 22 while compressing the spring 30 and thereby forcing product 2 out of the inner pump chamber 21 upwards towards the spout opening and the discharge valve for dispensing product out of the outlet 23, and for being opened when the user releases the actuator/removes the pressing force by means of the spring 30 returning the piston rod 42 and actuator 40 back into the first/start position while drawing out product 2 inside the container 3 via the pump chamber inlet 22 into the pump chamber to fill it, while closing the discharge valve(s) 51 and sealing or closing the pump chamber 21 to prevent product from flowing back into the container 3, making the dispenser pump 10 ready for subsequent pumping/dispensing.

In some embodiments, such as in FIGS. 1A to 4C, the dispenser 10 comprises a dip tube 60 made of a recyclable plastics material. The dip tube 60 is configured to extend from the inlet 22 of the pump chamber 21 with an adaptable length DTL into a predetermined depth DC of the container 3 depending on the type/size/length/height of the container. The dispenser 10 is applicable to differently sized and formed container 3. In some embodiments, e.g. shown in FIGS. 1A to 4C, a free end 60A of the dip tube 60 configured for receiving product 2 is cut into a predetermined shape and/or angle and/or size. In some embodiments, the free end 60A of the dip tube 60 comprises predefined markings and/or notches that aid in cutting at the correct angle and/or at the correct level/length and/or comprises another shape at the free end 60A, e.g. comprising a decreasing/narrowing size/diameter the closer the end, which decreasing size/diameter in some embodiments are marked by notches or the like. The dip tube 60 is at least partly tubular in some embodiments and/or in some embodiments a rounded or cylindrical tube along its whole length.

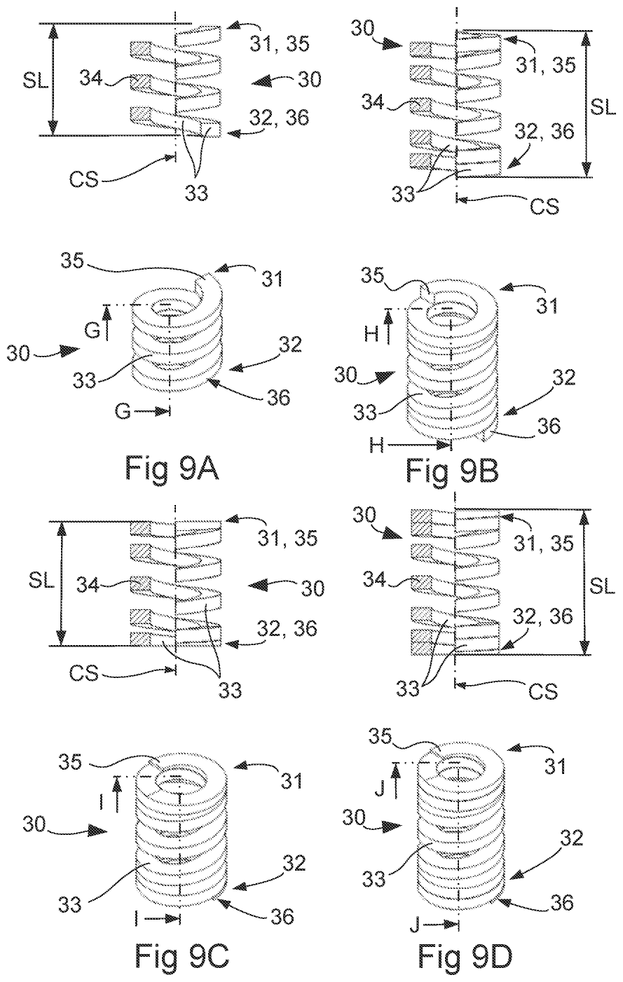

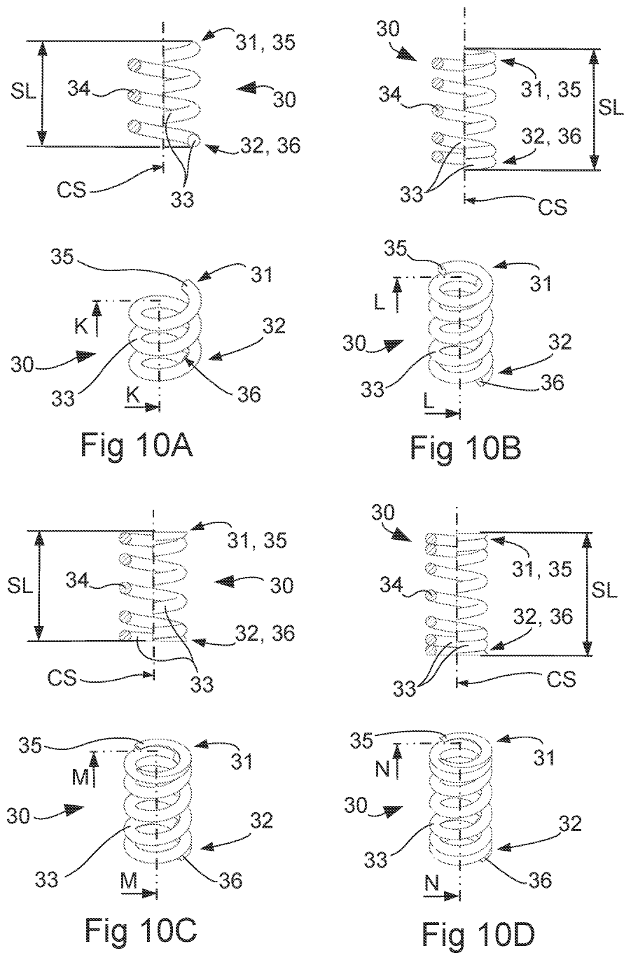

The second aspect of this disclosure shows in FIGS. 9A to 10D a spring 30 for a dispenser pump 10 according to any preceding embodiment/aspect, which spring 30 has a helical shape and is made of a recyclable plastics material and is at least partly shaped as a cylindrical helical spring and/or non-cylindrical helical spring. In the second aspect of this disclosure, there is a spring 30 for a dispenser pump 10 according to any preceding embodiment/aspect, which spring 30 has a helical shape and is made of a recyclable plastics material and is at least partly shaped as a non-cylindrical helical spring. In the second aspect of this disclosure, there is shown a spring 30 for a dispenser pump 10 according to any preceding embodiment and/or aspect, which spring 30 has a helical shape and is made of a recyclable plastics material and is at least partly shaped as a cylindrical helical spring and a non-cylindrical helical spring.

In some embodiments of the first and/or second aspect of this disclosure, the spring 30 is configured with and/or for manufacture into a non-cylindrical shape being substantially symmetrical or symmetrical around its centre axis CS. The spring centre axis CS is shown in all figs. as substantially or perfectly aligned with the longitudinal axis CD of the whole dispenser pump 10, but, in some embodiments not shown, the axes CS and CD are not substantially or perfectly in alignment/parallel with each other, i.e. in some embodiments they extend in deviating directions and/or extend at an angle relative each other.

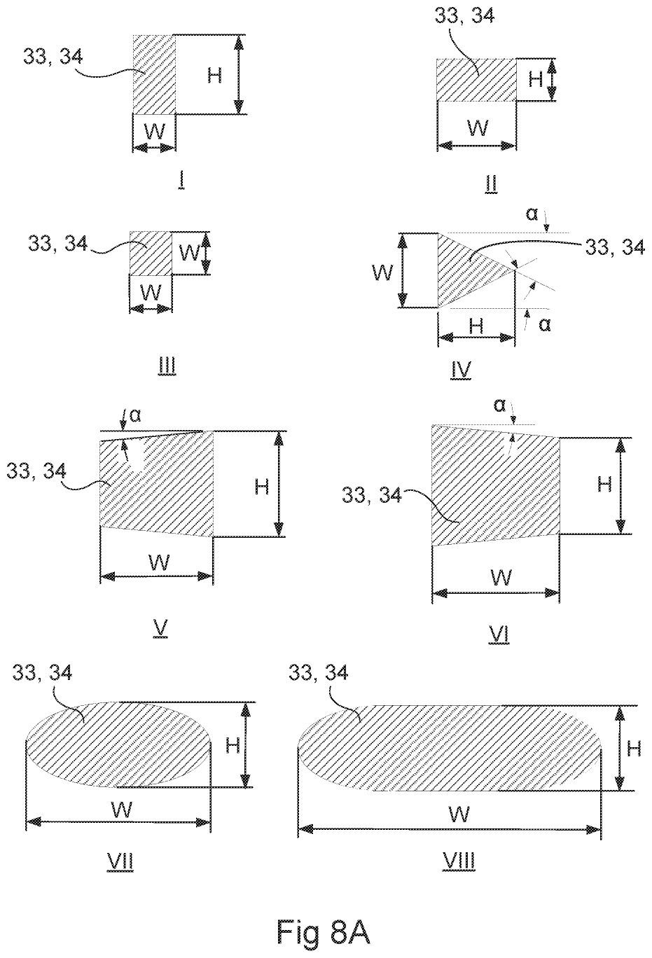

The spring 30 is in some embodiments configured with and/or for manufacture into the shape of a helically winded wire 33 with a polygonal cross-section 34 as seen in FIGS. 1C, 2C, 3C, 4C, 8A, 8B and 9A to 9D, which preferably is solid but could be at least partly hollow. FIGS. 8A, 8B show some different possible and suitable cross-sections 34 and I-VIII of the helically winded spring wire 33 of the spring 30. In views I, II and III of FIG. 8A and in corresponding views in 8B, the spring wire cross-section 34 is shown in polygonal shapes having four sides extending at perpendicular angles to each other, such as parallelepipeds with perpendicular angles at their corners or made up of perpendicular parallelograms. In views I and II of FIG. 8A and in corresponding views in 8B, the spring wire cross-section 34 is shown in rectangular shapes. In view I of FIG. 8A and in corresponding views in 8B, the spring wire cross-section 34 is shown as a standing rectangle. In view II of FIG. 8A and in corresponding views in 8B, the spring wire cross-section 34 is shown as a rectangle lying down. These rectangles may have different widths W and heights H. In view III of FIG. 8A and in corresponding views in 8B, the spring wire cross-section 34 is shown as a square, e.g. a cuboid or a parallelepiped with perpendicular angles at the corners or made up of perpendicular parallelogram with sides of the same length.

The spring 30 is in some embodiments configured with and/or for manufacture into the shape of a helically winded wire 33 with a triangular cross-section 34 as shown in view IV of FIG. 8A and in corresponding views in FIG. 8B with a width or base W and a height H. Here, the triangle is shown in an embodiment with equilateral sides, wherefore its size or length of its width or base W is the same as the length of the other two sides but could in other embodiments be non-equilateral and/or have one perpendicular angle meaning that the length of each cathetus of right triangle cross-section 34 would correspond to W and H, respectively. In some embodiments, the triangle 34 pointing to the right in FIG. 8A and in corresponding views in FIG. 8B radially away from the spring centre axis CS could in other embodiments point to the left radially inwards towards the spring centre axis CS or at least point in a direction deviating from a perfect radial direction of the spring 30.

In some embodiments as seen in views V and VI of FIGS. 8A and correspondingly in FIG. 8B, the spring 30 is configured with and/or for manufacture into the shape of a helically winded wire 33 with a conical cross-section 34. In view V of FIG. 8A and in corresponding views in FIG. 8B, the conical spring wire cross-section 34 is arranged with its apex directed radially inwards towards the spring centre/longitudinal axis CS. In view VI of FIG. 8A and in corresponding views in FIG. 8B, the conical spring wire cross-section 34 is arranged with its apex directed radially outwards from the spring centre/longitudinal axis CS. Spring cross-section 34 has an angle α defining the conicity of the conical spring wire cross-sections of views V and VI in FIG. 8A and in corresponding views in FIG. 8B and/or the deviation of the sides of the triangular spring wire cross-section of view IV in FIG. 8A and in corresponding views in FIG. 8B, which angle α is configured for being at least between 1° and 10° in some embodiments, and preferably between 1° and 5° and/or about between 2° and 4°, most preferred about 2°. The angle α improves manufacture by moulding due to fulfilling suitable relief angles. Furthermore, this angle α could in some embodiments be different on the upper side compared to the lower side of the spring wire cross-sections 34 of views IV, V and VI in FIG. 8A and in corresponding views in FIG. 8B, but is preferably substantially the same or exactly the same (within the tolerances of the technical field). In views V and VI in FIG. 8A and in corresponding views in FIG. 8B, only the upper side of the conical cross-sections 34 are shown with the angle α, which of course also is present at the lower side as shown for the triangular version in view IV. In some embodiments, the angles α do not have to be the same. In some embodiments, there could be only one angled side, e.g. angle α could exist only on the upper side as shown in FIG. 8A and in corresponding views in FIG. 8B, views V and VI or angle α could exist only at/on/along the lower side where the width W is defined opposite the shown upper location of angle α. In other words, angle α could be 0° or 180° relative the horizontal direction/plane or the direction of the width at the lower or upper side but be 2° at the opposite side, i.e. the upper/top or lower/bottom side of the cross-sections 34 shown in views V and VI in FIG. 8A, see corresponding views in FIG. 8B could be straight and not angled with angle α.

In some embodiments, the spring 30 is configured with and/or for manufacture into the shape of a helically winded wire 33 with a polygonal cross-section 34, see FIGS. 8A, 8B and 9A to 9D, having a/an width/extension W in the radial direction of the spring being less, equal or larger than its height/thickness/extension H in the axial/longitudinal direction of the spring. In the embodiment with equal measures, i.e. dimensions, the width W is the same as the height H, i.e. W=H, such as a quadratic cross-section 34. In the embodiment with differing measures, i.e. the width W is less or larger than the height H, i.e. W<H or W>H, such as a standing or lying down rectangular cross-section 34.

In some embodiments, such as in view V of FIG. 8A and in corresponding views in FIG. 8B, the conical cross-section 34 of the spring 30 points to the left in FIG. 8A and in corresponding views in FIG. 8B radially inwards and towards the spring centre axis CS. In some embodiments, such as in view VI of FIG. 8A and in corresponding views in FIG. 8B, the conical cross-section 34 of the spring 30 points to the right radially outwards and away from the spring centre axis CS. In some embodiments, the conical cross-section 34 could at least point in a direction deviating from a perfect radial direction of the spring 30. The spring 30 is in some embodiments a helical spring or even a conical helical spring comprising any of the above wire cross-sections 34, e.g. rectangular or triangular or conical wire cross-sections or a combination of two or more such wire cross-sections 34 depending on the application of the spring 30 in a suitably configured dispenser pump 10. The spring 30 is, in some embodiments, at least partly shaped as a conical helical spring 30. In some embodiments, the spring 30 is at least partly shaped as a straight helical spring 30, see FIGS. 1A to 10D. The spring 30 is at least partly shaped as a conical helical spring 30 with its apex arranged for facing towards the container opening 3A in some embodiments. The spring 30 is at least partly shaped as a conical helical spring 30 with its apex arranged for facing towards the container bottom 3B in some embodiments. The spring 30 is at least partly shaped as a conical helical spring 30 with its apex configured for facing towards the spout 41 in some embodiments. In some embodiments, the spring 30 is a straight helical spring along its full length or a conical helical spring along its full length or a combination of straight and conical along its length with varying distribution or length sections along the length, e.g. a straight section being longer or shorter than the conically shaped section of the spring length.

According to some embodiments, the spring 30 when comprising and/or being configured with and/or for manufacture into the shape of a helically winded wire 33 with a conical cross-section 34 has a simplified manufacture, e.g. by enabling angle of clearance, see views V and VI of FIG. 8A and in corresponding views in FIG. 8B, if moulding is used, e.g. by providing the mould with a smooth centre axle and two mould halves that are able to move perpendicular to the centre axle of the mould and when the mould halves are opened spring 30 is easily removed from the mould.

In FIG. 1C, the spring 30 and its end 32 are held or guided by being held from the outside by a circumferential flange and from the inside by a center guide at the upper side/top of closure 4 lowering the height of the dispenser pump 10 outside/externally of the container 3.

In FIG. 2C, the spring 30 and its end 32 are held or guided by being held from the outside by a circumferential flange and from below by a centre guide at the upper side/top of the closure 4, which may increase the height of the dispenser pump 10 outside/externally of the container 3 while providing a greater design freedom for the spring and also providing space for an inner smaller spring 30.

In FIG. 3C, a part of the spring 30 is arranged inside the container 3 decreasing the height of the dispenser pump 10 outside the container and enables the same design as prior art dispensers. The piston rod 42 configured for leading the product 2 as an inner channel is not arranged within the spring 30 in its longitudinal direction, this provides additional freedom in design of the inner diameter of the spring 30.

In FIG. 4C, a part of the spring 30 is arranged inside container 3 decreasing the height of the dispenser pump 10 outside the container and enables same design as prior art dispensers.

The spring 30 comprises a first end 31 and a second end 32 as shown in FIGS. 1A to 4C. In some embodiments of the spring 30, as shown in FIGS. 1C, 2C, 3C and 4C, at least one of its ends 31 or 32 is flattened and/or face grinded. As shown in FIGS. 1C, 2C, 3C and 4C, some embodiments of the spring 30 has both its first end 31 and second end 32 flattened and/or face grinded. In some embodiments of the spring 30 shown in FIGS. 1A to 7C, one or more or all of its ends 31, 32 are flattened and/or face grinded in a plane being perpendicular to the center/longitudinal axis CS of the spring.

In FIG. 8A and in corresponding views in FIG. 8B, the cross-sections 34 of a spring wire 33 of one or more springs 30 are also shown with an oval and/or elliptical cross-section 34 in views VII and VIII. These cross-sections are alternative ones. In some embodiments, the cross-section 34 could be any combination of one or more of non-rounded ones as shown in views I to VI of FIG. 8A; in corresponding views in FIG. 8B, and upper views of 9A to 9D and rounded ones, such as the circular and/or oval and/or elliptical ones shown in views VII to VIII of FIG. 8A and in corresponding views in FIG. 8B and upper views of FIGS. 10A to 10D.

The cross-sections 34 shown in views V, VI, VII and VIII in FIG. 8A; in corresponding views in FIG. 8B and upper views of FIGS. 9A-9D could be rearranged or reorientated by being turned 90° to the left/counterclockwise or right/clockwise, whereby the cross-sections 34 of views VII and VIII and upper views of FIGS. 9A-9D then would be “standing up” instead of laying down, and the apexes of the conical cross-sections 34 of views V and VI in FIG. 8A and in corresponding views in FIG. 8B would point either upwards towards end 31 of the spring or down towards the other spring end 32 instead of pointing either outwards from or inwards towards the center axis CS of the spring 30 as shown.

In FIG. 6, the dispenser pump 10 comprises a fixed nozzle, i.e. the spout 41 is fixated to the closure 4 of the dispenser pump. The dispenser pump 10 comprises a movable/operable button or actuator arrangement 43 arranged above the spout 41. The actuator comprises the operable button arrangement 43 that in turn comprises an upper part or face or end 44 at/on which a user presses when dispensing as explained above. The face end 44 is shaped and made larger than the part below for better and smoother feel when pressing on it. The face end 44 has a rounded shape and/or a mushroom head shape as shown in FIG. 6. The operable face 44 is operatively connected to and biased by the spring 30 upwards in the direction of the upper arrow head of the double arrow in FIG. 6. The user presses/pushes on the actuator face 44 and its button arrangement 43 in the direction of the lower arrow head of FIG. 6 whereby the button 43 and its face 44 moves down from its shown first position towards the spout 41 and a second and/or end and/or intermediary position (as for the other embodiments) to operate the dispenser pump 10 as explained above for the other embodiments and when the user stops pushing, i.e. ends the pressing force on the button arrangement 43, the spring 30 urges the actuator 40 with button 43 and its face 44 upwards back to return it to its start position as shown in FIG. 6.

In some embodiments, the spring 30 is being configured for manufacture by injection moulding and/or machining.

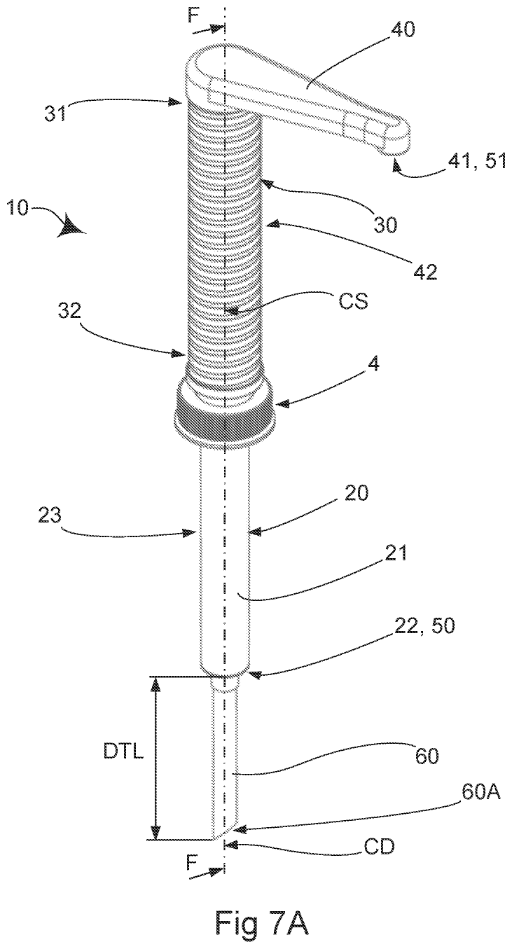

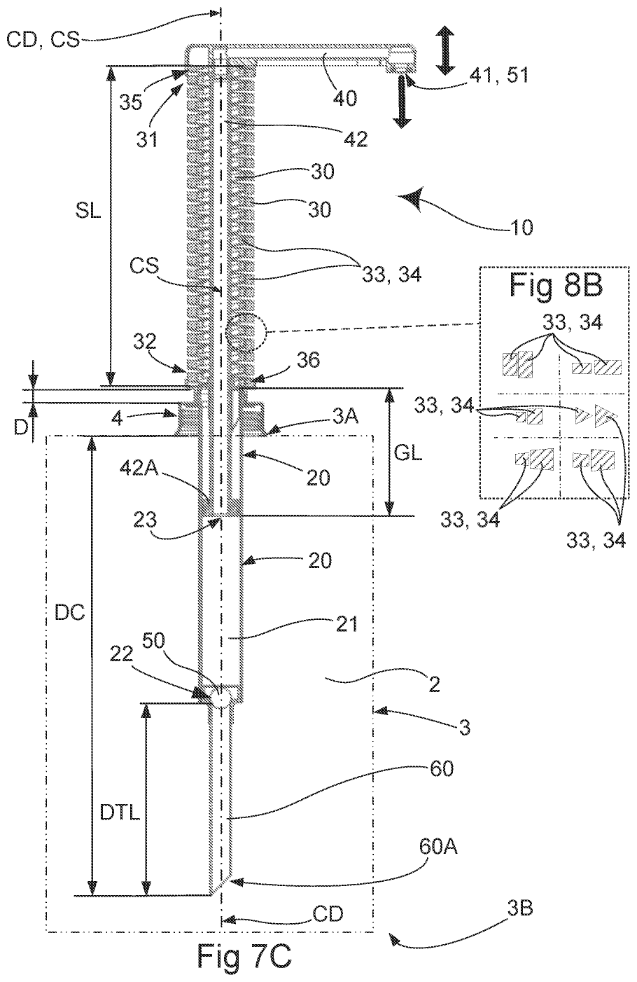

In FIGS. 7A, 7C and 8B, an embodiment of the spring 30 is shown as a twin spring 30. This spring could comprise at least two springs 30. One spring 30 is configured for being arranged inside another spring 30. A first spring 30 could have a size being adapted for fitting inside and/or being received within a second spring 30. Such a first spring 30 could have a size being adapted for fitting/being received within such a second spring 30. Such springs 30 could have essentially the same or the same length, i.e. spring length SL. A spring 30 made up of more than one separate spring is advantageous for long strokes. Such springs 30 could be arranged concentrically relative each other when one spring is placed within the other as seen in FIG. 7C. One advantage in having two springs as a twin spring 30, where one smaller spring 30 is arranged within a larger spring 30 as in FIG. 7C is that larger strokes/stroke length is achieved while minimizing the total volume occupied by the springs, i.e. the plastic material use and/or consumption is optimised in relation to available space for the springs 30. In some embodiments, see FIGS. 7C and 8B, by providing the spring 30 of the present disclosure as a twin or double spring with one smaller spring placed or arranged within or inside a larger one, the length of the spring 30 is reduced by about between 10-40% or about between 15-30% or preferably about 20% compared to using a single spring. By providing the spring 30 as a twin or double spring with one smaller spring placed or arranged within or inside a larger one, the total weight of the spring 30 is not increased compared to using a single spring. To avoid having the springs 30 of a twin spring entangled, one spring has its spring wire in right winding is and the other spring has its spring wire in a left winding, i.e. the springs have their wires winded in different directions, i.e. similar to one right-hand thread and one left-hand thread.

In a further preferred aspect of the disclosure, the dispenser pump 10 has a locked condition in which the piston rod or plunger 42 and the button arrangement 43 are held axially fixed and hence non-operable. This locking action requires the button arrangement 43 and its face end or head 44 to be depressed and turned at the same time into a locking mode, whereafter any undesirable leakage or dribble of product 2 from the spout 41 and/or swinging spout/nozzle if not a fixated one. This locking also prevents any undesired leakage or dispensing when the dispenser pump 10 is transported with a container 3 or the like or when on display in a shop or the like full with product. The unlocking is done in a reversed manner.

In some or all embodiments, the guiding of the reciprocating movement of the piston rod 42 is optimised/improved by the adapting of the location and/or positioning and/or size/dimensions and/or diameter of the closure 4 and its surfaces through which and in contact with the piston rod 42 moves and a free end 42A of the piston rod. The other end of the piston rod 42 is arranged closer to the spout 41. This adaptation of the guiding surfaces and their separation is visualized by a guiding length or distance GL as shown to the right in FIGS. 1C, 2C, 3C, 4C, 5C and 7C. This separation of the guiding surfaces at the closure 4 and the free end 42A of the piston rod 42 stabilizes the reciprocating movement of the piston rod and the operability of the whole dispenser pump 10 when used.

In FIG. 7C, the small view of FIG. 8B to the right discloses the wire 33 and its double cross-sections 34 side-by-side corresponding to the embodiments of FIG. 8A but in twin or double versions. Here, the inner spring 30 or outer spring 30 could be the left cross-section or the right cross-section 34 of the twin-spring. As the inner spring 30 preferably is smaller than the outer spring 30, the left cross-section is smaller in these views to correspond to this arrangement of a smaller spring inside a larger spring. A spring 30 with larger diameter forms an inner cavity into which a spring 30 with smaller diameter is fitted/introduced.

In some embodiments, see FIGS. 1A-1C, 2A-2C, 5A-5C, 7A and 7C, the spring 30 is not in physical contact with the product 2 providing a large freedom in choosing the plastic material(s) to make the spring as the plastic material(s) does/do not have to fulfill the strict requirements regarding food product 2 being in physical contact with plastics material(s). Another advantage is that there is no risk for the product 2 to be contaminated by the plastics material(s). Yet an advantage is that there is no risk that the product 2 affects the plastics material(s) negatively, such as deterioration or decay due to caustic or fraying or corrosive effect on the spring 30 and the plastic material(s) making up the spring such that the mechanical characteristics of the spring is degraded or worsened.

The spring wire 33 comprises a first spring wire end 35 and a second spring wire end 36, see FIGS. 1C, 2C, 3C, 4C, 5C, 7C, and 9A to 10D. One or more of the spring ends 31, 32 of the spring 30 according to the present disclosure comprises at least one free spring wire end 35, 36. Preferably, each of the spring ends 31, 32 of the spring 30 according to the present disclosure comprises one free spring wire end 35, 36.

In FIGS. 9A to 10D, embodiments of springs 30 comprising varying shapes of spring wire cross-sections 34 and/or embodiments of springs 30 comprising differently designed spring ends 31, 32 and spring wire ends 35, 36 are shown. In FIGS. 9A to 9D, embodiments of springs 30 comprising non-round and/or polygonal and/or parallelepipedic and/or square and/or quadratic and/or rectangular and/or conical shapes of spring wire cross-sections 34 are shown. In FIGS. 10A to 10D, embodiments of springs 30 comprising round and/or circular and/or oval and/or elliptical shapes of spring wire cross-sections 34 are shown.

In FIGS. 9A and 10A, embodiments of springs 30 comprising one or more open spring ends 31, 32 are shown. An open end 31, 32 means that the last wire ends 35, 36 of the spring 30 are open and have space or pitch in-between them, i.e. the coils or windings of the last wire ends 35, 36 of the spring wire 33 at the ends 31, 32 do not touch or are in contact with previous coils/windings. This is an advantage if to provide more force out of a spring 30 but there is not enough space for it. An open-ended spring 30 makes all of the spring coils active and the spring works more efficiently getting more usable spring force out of the spring. This kind of spring end 31, 32 requires that the spring 30 be arranged in a hole or on a shaft to ensure its function. There is less cost for this type of spring end 31, 32 being open thus making it an economical choice.

In FIGS. 9B and 10B, embodiments of springs 30 comprising one or more closed spring ends 31, 32 are shown. In FIGS. 9C and 10C, embodiments of springs 30 comprising one or more closed ground spring ends 31, 32, 35, 36 are shown. In FIGS. 9D and 10D, embodiments of springs 30 comprising one or more double closed ground spring ends 31, 32 are shown.

In some embodiments, see FIGS. 9B to 9D and 10B to 10D, the spring 30 comprises at least one closed spring end 31, 32. In some embodiments, see FIGS. 9B to 9D and 10B to 10D, the spring 30 comprises two closed spring ends 31, 32, i.e. each spring end is closed. A closed spring end 31, 32 means that at least the last coil or winding of the end 35, 36 of the wire 33 at an end 31, 32 of the spring 30 is in contact with or touching the previous coil or winding of the wire 33, but, at the same time, these coils and windings of the wire ends 35, 36 of the wire 33 are not hindered from moving. Hence, these coils and windings of the wire end 35, 36 of the wire 33 of a closed spring end 31, 32 are able or free to move, e.g. linearly and/or radially and/or in a rotative or twisting motion, in relation to each other, e.g. along each other and/or radially relative each other and/or the spring 30 when the spring is loaded and unloaded, see the cross-sectional views of FIGS. 9B to 9D and 10B to 10D. In other words, a closed spring end 31, 32 means that the spring wire 33 and its last wire end 35, 36 are not fixed or fixated or held stationary relative the previous coil or winding of the wire and are only abutting or laying or closing against the previous coil or winding of the wire with no free space or gap or distance between them seen in the longitudinal or axial direction of the spring 30, see the cross-sectional views of FIGS. 9B to 9D and 10B to 10D. In some embodiments, one or more coils or windings of the spring wire 33 at or ending at/in one or more spring and wire ends 31, 32, 35, 36 of the spring 30 is/are closed. In some embodiments, one or more of the last coils or windings of the spring wire 33 at/in one or more spring and wire ends 31, 32, 35, 36 of the spring 30 is/are closed. In the embodiments of FIGS. 9B to 9D with spring wire 33 with a closed wire end 35, 36 at each spring end 31, 32 and squared cross-section 34, this design is the most economical of all spring end types and works well for standing up normal size springs. However, closed and polygonal and/or squared and/or rectangular and/or quadratic ends 31, 32, 34, 35, 36 of the wire 33 do not work well if using a spring 30 with a small outer diameter, in that case, closed and ground spring ends 31, 32 must be chosen if the spring 30 is to be able to stand up vertically straight without any support such as the flange at enclosure 4.

In some embodiments, see FIGS. 9C to 9D and 10C to 10D, the spring 30 comprises at least one closed and grounded spring end 31, 32. In some embodiments, see FIGS. 9C to 9D and 10C to 10D, the spring 30 comprises two closed and grounded spring ends 31, 32, i.e. each spring end is closed and grounded. Here, the last spring wire coil or winding of one or more spring ends 31, 32 of the spring 30 is closed and ground flat touching with the previous spring wire coil/winding. A closed and ground end 31, 32 of a spring 30 helps the spring stand up vertically straight. This type of spring end 31, 32 lets the spring 30 stand up straight and gives an even surface of contact to the spring base. This type of spring end 31, 32 of a spring 30 is a good choice for precision springs but are more costly than only closed and squared ends, i.e. squared cross-section 34, as additional labour needs to be performed to grind the ends 31, 32 of the spring 30 flat.

In some embodiments, see FIGS. 9D and 10D, the spring 30 comprises at least one double closed spring end 31, 32. In some embodiments, see FIGS. 9D and 10D, the spring 30 comprises two double closed spring ends 31, 32, i.e. each end is double closed. Here, the last two spring wire coils or windings on each spring end 31, 32 are closed to help stabilize the top and bottom of the spring 30. Double-closed ends 31, 32 aids the footing of the spring, in particular when the spring 30 comprises a large outer measure/diameter coupled with a fine or small diameter for the spring wire 33 when compressed or traveling to stacked height where all the spring wire coils or windings are in contact, i.e. touching. A double-closed end 31, 32 keeps a spring end 31, 32 and wire ends 35, 36 from sliding over or slipping under the previous coil/winding, and keeps the spring wire coils/windings stacked up on top of each other correctly. This type of spring ends 31, 32 is a great economical choice to prevent buckling and stabilizes the spring 30.

In some embodiments, see FIGS. 9D and 10D, the spring 30 comprises at least one double closed and grounded spring end 31, 32. In some embodiments, see FIGS. 9D and 10D, the spring 30 comprises two double closed and grounded spring ends 31, 32, i.e. each end is double-closed and grounded. This type of spring ends 31, 32 utilises the advantages of both double-closed type of spring and wire ends 35, 36 and grounded type of spring and wire ends.

In some embodiments, the recyclable plastic material is within the same family of plastic, e.g. polyolefin. In some embodiments, the recyclable plastic material is Polyamide. In some embodiments, the recyclable plastic material is a combination or mixture of Polyamide and Polypropylene. In some embodiments, the recyclable plastic material is 100% Polyamide. In some embodiments, the recyclable plastic material is a combination or mixture of 90 to 98% of Polyamide (percentage by weight) and 2 to 10% of Polypropylene (percentage by weight). In some embodiments, the recyclable plastic material comprises up to 40% glass fibre (percentage by weight). In some embodiments, the recyclable plastic material is a combination of up to 40% glass fibre (percentage by weight) and other plastic material(s), such as Polyamide and/or Polypropylene according to any of the other embodiments. In some embodiments, the recyclable plastic material is a mixture of up to 40% glass fibre (percentage by weight) and other plastic material(s), such as Polyamide and/or Polypropylene or a combination of up to 40% glass fibre (percentage by weight) mixed with other plastic material(s), such as Polyamide and/or Polypropylene according to any of the other embodiments. In some embodiments, the recyclable plastic material comprises up to 40% glass fibre (percentage by weight) besides the amount of other plastic material(s), such as Polyamide and/or Polypropylene according to any of the above embodiments.

The person skilled in the art realizes that the present disclosure is not limited to the preferred embodiments described above. The person skilled in the art further realizes that modifications and variations are possible within the scope of the appended claims. For example, disclosed spring 30 is applicable for any dispenser pump having a moving spout 41 or fixated/stationary one. If the spring 30 is applied in a dispenser pump 10 with a fixed spout or nozzle 41, the dispensing of product 2 is achieved by leading the product along another path than shown in the disclosed figs. The twin spring 30 of FIGS. 7A, 7C and 8B could be made up of springs 30 with different cross-sections, e.g. the inner smaller helical spring 30 could be windings of a wire with a quadratic cross-section 34 as shown in FIGS. 1C, 2C, 5C, 7C and 8B while the outer larger helical spring 30 would not have a quadratic wire cross-section as shown in FIGS. 7C and 8B, instead outer spring 30 could have a rectangular wire cross-section 34 (e.g. “standing up”) as shown in FIGS. 3C and 4C or vice versa. In some embodiments, the twin spring 30 of FIGS. 7A, 7C, 8A and 8B could be made up of springs 30 with one or more different plastic materials. In some embodiments, the twin spring 30 of FIGS. 7A, 7C, 8A and 8B could be made up of springs 30 with different cross-sections and one or more different plastic materials. In some embodiments, the cross-section 34 of the inner and/or the outer helical spring 30 could be any combination of one or more of non-rounded ones as shown in views I to VI of FIG. 8A and FIGS. 9A to 9D and rounded ones, such as the circular and/or oval and/or elliptical ones shown in views VII to VIII of FIG. 8A and FIGS. 10A to 10D. In some embodiments, the spring 30 could comprise a combination of one open spring end 31, 32 and one closed end 31, 32. In an embodiment, the spring 30 could comprise a combination of one open spring end and one closed and grounded spring end 31, 32. In some embodiments, the spring 30 could comprise a combination of one open spring end and one double closed and grounded spring end 31, 32. In an embodiment, the spring 30 could comprise a combination of one closed spring end 31, 32 and one closed and grounded spring end. In an embodiment, the spring 30 could comprise a combination of one closed spring end 31, 32 and one double closed spring end. In some embodiments, the spring 30 could comprise a combination of one closed and grounded spring end 31, 32 and one double closed spring end. In an embodiment, the spring 30 could comprise a combination of one closed spring end 31, 32 and one double closed and grounded spring end. In an embodiment, the spring 30 could comprise a combination of one closed and grounded spring end 31, 32 and one double closed and grounded spring end.

In some embodiments, the spring(s) 30 are configured such that they cannot be overloaded or overstressed, this being accomplished in that when the tension or stress in the plastic material(s) of the spring(s) 30 reaches about 60% or 60% of the yield point or yield strength for the plastics material(s), the spring(s) 30 bottom(s) meaning that the spring(s) is/are fully compressed such that all the spring wire windings of the wire 33 are in contact, i.e. closed, with no free space between them, and cannot be deformed more. This makes the spring 30 more robust and less prone for fatigue failure and/or creep strain/rupture.

Additionally, variations to the disclosed embodiments can be understood and effected by the skilled person in practicing the claimed disclosure, from a study of the drawings, the disclosure, and the appended claims. A free wire end 35, 36 of the wire 33 of the spring 30 means the end of the last coil or winding of the wire 33 at a spring end 31, 32 of the spring. This free wire end 35, 36 of the spring 30 is not hindered from moving. Hence, this free wire end 35, 36 and/or last coil/winding is not fixed or fixated or held stationary in relation to the previous coil or winding of the wire 33. In other words, the definition of free in “free wire end” 35, 36 is not defined as a wire end only being free from contact with any other coil or winding of the wire 33 as shown in the embodiments of FIGS. 9A and 10A, i.e. this wire end 35, 36 is also defined as free to move even though that this wire end 35, 36 in the last coil or winding of a spring end 31, 32 is at least partially in physical contact with a previous coil or winding of the wire 33 as shown in the embodiments of FIGS. 9B, to 9D and 10B to 10D. One or more free wire ends 35, 36 and/or coils/windings at/in one or more spring ends 31, 32 of any or all the embodiments of the spring 30 according the present disclosure, including the double-closed ones in the embodiments of the spring 30 in FIGS. 9D and 10D, is/are free to move in relation to each other and not fixed, such as in an integrated collar at a spring end 31, 32.

1. A dispenser pump (10) for manual dispensing of product (2) in fluid form out of a container (3) and for leakproof assembly to an opening (3A) of the container by means of a closure (4), the dispenser pump defining a longitudinal axis (CD) and comprising a housing (20) adapted for being held fixed/stationary/axially in relation to the container after assembly, the housing defining a pump chamber (21) with an inlet (22) configured for fluid communication with the inside of the container, the dispenser pump comprising at least one spring (30), an actuator (40), a spout (41) being configured for fluid communication with the inside of the pump chamber, and a piston rod (42) fixedly connected to the actuator and arranged for reciprocating motion inside the pump chamber, wherein the actuator is configured for moving together with its piston rod reciprocally relative the housing (20) between a first/start position and an end and/or intermediary and/or activated position to pump product (2) out of the container via the spout (41) by use of a pressing force applied by a user to the actuator to move the actuator from its first or start position towards the housing and closure into its end and/or intermediary and/or activated position with its piston rod moving inside the pump chamber along the longitudinal dispenser pump axis and an elastic force of the spring to return the actuator with piston rod from the end or intermediary/activated position to the first position after the pressing force is removed for sucking in product into the pump chamber (21), characterized in that that all parts of the dispenser pump (10) are manufactured by recyclable plastic material including the spring (30) having a helical shape, that the spring comprises a wire (33) and a first end (31) and a second end (32), wherein the wire is provided with a free wire end (35, 36) at each of the first and second ends of the spring.

2. The dispenser pump (10) according to claim 1, wherein the spring (30) is configured for arrangement at least partly outside the container (3) and/or the pump housing (20) and/or the pump chamber (21) and/or the piston rod (42).

3. The dispenser pump (10) according to claim 1, wherein the spring (30) is configured for being arranged at least partly inside the container (3) and/or the pump housing (20) and/or the pump chamber (21) and/or the piston rod (42).

4. The dispenser pump (10) according to claim 3, wherein the spring (30) is configured for being arranged inside the container (3) and the pump housing (20) and the pump chamber (21).

5. The dispenser pump (10) according to claim 3, wherein the spring (30) is configured for being arranged at least partly inside the container (3) and the pump housing (20) and the pump chamber (21) and the piston rod (42).

6. The dispenser pump (10) according to claims 2 and 3, wherein the spring (30) is configured for being arranged at least partly inside the container (3) and the pump housing (20) and configured for being arranged at least partly outside the pump chamber (21) and the piston rod (42).

7. The dispenser pump (10) according to any preceding claim, wherein the pump chamber (21) is configured for being located at least partly below the closure (4).

8. The dispenser pump (10) according to claim 7, wherein the pump chamber (21) is configured for being located wholly below the closure (4).

9. The dispenser pump (10) according to any preceding claim, wherein the spring (30) is relaxed when the actuator (40) is in its first/start position before its first use/stroke.

10. The dispenser pump (10) according to claim 9, wherein the spring (30) is under compression when the actuator (40) has returned to its start position after its first stroke from the start position to the end/activated position and back to the first/start position, this first stroke being a first priming stroke for enabling filling the pump chamber (21) with product (2).

11. The dispenser pump (10) according to any of claims 1 to 10, wherein the spring (30) is under compression when the actuator (40) is in its first/start position before its first use/stroke.

12. The dispenser pump (10) according to any preceding claim, wherein the spring (30) is configured for being arranged at least partly between the container (3)/pump housing (20)/chamber (21)/closure (4) and the spout (41).

13. The dispenser pump (10) according to claim 12, wherein the spring (30) is configured for being arranged wholly between the container (3)/pump housing (20)/chamber (21)/closure (4) and the spout (41).

14. The dispenser pump (10) according to any of claims 1 to 11, wherein the spring (30) is configured for being arranged wholly below the closure (4) and/or spout (40).

15. The dispenser pump (10) according to any of claims 1 to 13, wherein the spring (30) is configured for being arranged at least partly at/adjacent/close to/above the spout (40).

16. The dispenser pump (10) according to claim 14 or 15, wherein the spring (30) is configured for being arranged inside the container (3) and/or pump housing (20) and/or pump chamber (21) at a distance (D) from the closure (4).

17. The dispenser pump (10) according to claim 10 or 11 or any of claims 12 to 16 when dependent on claim 10, further comprising a check valve (50) made of a recyclable plastics material and configured for being arranged at the pump chamber inlet (22) and a discharge valve (51) made of a recyclable plastics material and configured for being arranged at the spout (41), the check valve (50) is configured for being closed, when the user presses down on the actuator (40) and moves the piston rod (42) towards the pump chamber inlet compressing the spring (30) while forcing product (2) out of the pump chamber (21) upwards towards the spout opening the discharge valve for dispensing product, and for being opened when the user releases the actuator/removes the pressing force by means of the spring returning the piston rod and actuator back into the first/start position while drawing out product inside the container (3) into the pump chamber to fill it, while closing the discharge valve and sealing or closing the pump chamber to prevent product from flowing back into the container once the pump chamber is filled.

18. The dispenser pump (10) according to claim 17, further comprising a dip tube (60) made of a recyclable plastics material and configured to extend from the inlet (22) of the pump chamber (21) with an adaptable length (DTL) into a predetermined depth (DC) of the container (3) depending on the type/size/length/height of the container.

19. The dispenser pump (10) according to claim 18, wherein a free end (60A) of the dip tube (60) configured for receiving product (2) is cut into a predetermined shape and/or angle and/or size and/or diameter.

20. The dispenser pump (10) according to any preceding claim, wherein the actuator (40) and the spout (41) are configured to be movable together as one unit.

21. The dispenser pump (10) according to any of claims 1 to 19, wherein the actuator (40) is configured to be movable and the spout (41) is stationary/fixated.

22. The dispenser pump (10) according to any of claims 1 to 21, wherein the spring (30) is a twin spring (30).

23. The dispenser pump (10) according to any of claims 1 to 22 comprising at least two springs (30).

24. The dispenser pump (10) according to claim 22 or 23, wherein one spring (30) is configured for being arranged inside another spring.

25. The dispenser pump (10) according to any of claims 22 to 24, wherein a first spring (30) has a size and/or diameter being adapted for fitting within a second spring.

26. The dispenser pump (10) according to any of claims 22 to 25, wherein a first spring (30) having a size being adapted for fitting/being received within a second spring, which springs have essentially same or the same length (SL).

27. The dispenser pump (10) according to any of claims 22 to 26, wherein a first spring (30) is adapted for fitting/being received within a second spring, the springs being concentrically arranged.

28. The dispenser pump (10) according to claim 27, wherein the centre axis (CS) of the first spring (30) is aligned with the center axis (CS) of the second spring (30).

29. A spring (30) for a dispenser pump (10) according to any preceding claim, wherein the spring (30) has a helical shape and is made of a recyclable plastics material and is at least partly shaped as a cylindrical and/or non-cylindrical helical spring.

30. The spring (30) according to claim 29 comprising and/or configured for manufacture into and/or configured with a non-cylindrical shape being substantially symmetrical or symmetrical around its centre axis (CS).

31. The spring (30) according to claim 29 and/or 30 comprising and/or configured for manufacture into and/or configured with the shape of a helically winded wire (33) with a polygonal cross-section (34).

32. The spring (30) according to claim 29, 30 or 31 comprising and/or configured with and/or configured for manufacture into the shape of a helically winded wire (33) with a square cross-section (34).

33. The spring (30) according to any of claims 29 to 32 comprising and/or configured with and/or configured for manufacture into the shape of a helically winded wire (33) with a rectangular cross-section (34).

34. The spring according to any of claims 29 to 32 comprising and/or configured with and/or configured for manufacture into the shape of a helically winded wire (33) with a quadratic cross-section (34).

35. The spring (30) according to any of claims 29 to 31 comprising and/or configured with and/or configured for manufacture into the shape of a helically winded wire (33) with a triangular cross-section (34).

36. The spring (30) according to any of claims 29 to 32 comprising and/or configured for manufacture into the shape of a helically winded wire (33) with a conical cross-section (34).

37. The spring (30) according to claim 36, wherein the conical wire cross-section (34) is arranged with its apex directed radially outwards from the spring centre/longitudinal axis (CS).

38. The spring (30) according to claim 36, wherein the conical wire cross-section (34) is arranged with its apex directed radially inwards towards the spring centre/longitudinal axis (CS).

39. The spring (30) according to any preceding claim, wherein the spring (30) is configured for manufacture into the shape of a helically winded wire (33) with a polygonal cross-section (34) having a/an width/extension (W) in the radial direction of the spring being less, equal or larger than its height/thickness/extension (H) in the axial/longitudinal direction of the spring.

40. The spring (30) according to any of claims 29 to 39 being at least partly shaped as a conical helical spring, wherein its apex is configured for facing towards the container bottom (3B) when the dispenser pump (10) is mounted thereto.

41. The spring (30) according to any of claims 29 to 39 being at least partly shaped as a conical helical spring, wherein its apex is configured for facing towards the container opening (3A) when the dispenser pump (10) is mounted thereto.

42. The spring (30) according to any of claims 29 to 39 being at least partly shaped as a conical helical spring, wherein its apex is configured for facing towards the spout (41) when the spring (30) is assembled in the dispenser pump (10).

43. The spring (30) according to claim 29 or 30, comprising and/or configured for manufacture into and/or is configured with the shape of a helically winded wire (33) with an oval and/or elliptical cross-section (34).

44. The spring (30) according to any of claims 29 to 43, wherein the spring (30) is a twin spring.

45. The spring (30) according to any of claims 29 to 44 comprising at least two springs (30).

46. The spring (30) according to claim 45, wherein one spring (30) is configured for being arranged inside another spring (30).

47. The spring (30) according to claim 45 or 46, wherein a first spring (30) has a size being adapted for fitting/being received within a second spring (30).

48. The spring (30) according to any of claims 45 to 47, wherein a first spring (30) has a size being adapted for fitting/being received within a second spring (30), which springs have essentially the same or the same length (SL).

49. The spring (30) according to any of claims 29 to 47 comprising a first end (31) and a second end (32), wherein at least one end is flattened and/or face grinded.

50. The spring (30) according to claim 49, wherein both its first end (31) and second end (32) are flattened/face grinded.

51. The spring (30) according to claim 49 or 50, wherein the end (31, 32) is flattened and/or face grinded in a plane being perpendicular to the centre/longitudinal axis (CS) of the spring.

52. The spring (30) according to any preceding claim being configured for manufacture by injection moulding and/or machining.

53. The spring (30) according to any preceding claim being configured with a helical envelope surface formed by the outer surface of the helically winded wire, which windings form an at least partly open structure when the spring is relaxed.

54. The spring (30) according to any preceding claim, comprising one or more open ends (31, 32).

55. The spring (30) according to any of the claims 1 to 53, comprising one or more closed ends (31, 32).

56. The spring (30) according to any of the claim 1 to 53 or 55, comprising one or more closed and grounded ends (31, 32).

57. The spring (30) according to any of the claim 1 to 53 or 55 or 56, comprising one or more double closed and grounded ends (31, 32).
